(19) United States
(12) Patent Application Publication
(10) Pub. No.: US 2010/0159337 A1
(43) Pub. Date: Jun. 24, 2010

(54) ANODE AND SECONDARY BATTERY

(75) Inventors: Koichi Matsumoto, Fukushima (JP); Kenichi Kawase, Fukushima (JP); Isamu Konishiike, Kanagawa (JP); Shunsuke Kurasawa, Fukushima (JP); Masayuki Iwama, Fukushima (JP); Takakazu Hirose, Fukushima (JP); Takashi Fujinaga, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/643,450

(22) Filed: Dec. 21, 2009

(30) Foreign Application Priority Data
Dec. 22, 2008 (JP) 2008-326501

(51) Int. Cl. H01M 10/0564; H01M 4/02; H01M 4/38; H01M 4/52; H01M 4/42; H01M 10/056

(52) U.S. Cl. 429/337; 429/209; 429/220; 429/221; 429/223; 429/229; 429/231.5; 429/207; 429/205

(57) ABSTRACT

A secondary battery is provided that is capable of improving the cycle characteristics. The secondary battery includes a cathode, an anode, and an electrolytic solution. The electrolytic solution is impregnated into a separator provided between the cathode and the anode. In the anode, an anode active material layer and a compound layer are provided on both faces of an anode current collector. The anode active material layer contains a plurality of anode active material particles. The anode active material particles have a multilayer structure of an anode active material containing silicon as an element. The thickness of each layer in the multilayer structure ranges from 50 nm to 1050 nm. Thus, contact characteristics between each layer, contact characteristics between the anode active material layer and the anode current collector, and current collectivity are improved.

### CROSS REFERENCES TO RELATED APPLICATIONS

The present application claims priority to Japanese Priority Patent Application JP 2008-326501 filed in the Japan Patent Office on Dec. 22, 2008, the entire content of which is hereby incorporated by reference.

### BACKGROUND

The present disclosure relates to an anode in which an anode active material layer that contains an anode active material containing silicon (Si) as an element on an anode current collector and a secondary battery including the same.

In recent years, portable electronic devices such as combination cameras (videotape recorder), mobile phones, and notebook personal computers have been widely used, and it is strongly demanded to reduce their size and weight and to achieve their long life. Accordingly, as a power source for the portable electronic devices, a battery, in particular a light-weight secondary batter capable of providing a high energy density has been developed.

Specially, a secondary battery using insertion and extraction of lithium for charge and discharge reaction (so-called lithium ion secondary battery) is extremely prospective, since such a secondary battery is able to provide a higher energy density compared to a lead battery and a nickel cadmium battery.

The lithium ion secondary battery includes an anode having a structure in which an anode active material layer containing an anode active material is provided on an anode current collector. As the anode active material, a carbon material has been widely used. However, in recent years, as the high performance and the multi functions of the portable electronic devices are developed, further improving the battery capacity is demanded. Thus, it has been considered to use silicon instead of the carbon material. Since the theoretical capacity of silicon (4199 mAh/g) is significantly higher than the theoretical capacity of graphite (372 mAh/g), it is prospected that the battery capacity is thereby highly improved.

However, in the case where the anode active material layer is formed by depositing silicon as an anode active material by vapor-phase deposition method, the binding characteristics are not sufficient. Thus, if charge and discharge are repeated, there is a possibility that the anode active material layer is intensely expanded and shrunk to be pulverized. If the anode active material layer is pulverized, depending on the pulverization degree, an irreversible lithium oxide is excessively formed resulting from increase of the area surface, and current collectivity is lowered resulting from dropping from the anode current collector. Accordingly, the cycle characteristics as important characteristics of the secondary battery are lowered.

Therefore, to improve the cycle characteristics even when silicon is used as the anode active material, various devices have been invented. Specifically, a technique to form the anode active material layer as a multilayer structure by depositing silicon several times in vapor-phase deposition method has been disclosed (for example, refer to Japanese Unexamined Patent Application Publication No. 2007-317419). In addition, a technique to cover the surface of the anode active material with a metal such as iron, cobalt, nickel, zinc, and copper (for example, refer to Japanese Unexamined Patent Application Publication No. 2000-036323), a technique to diffuse a metal element such as copper not being alloyed with lithium in an anode active material (for example, refer to Japanese Unexamined Patent Application Publication No. 2001-273892), a technique to form a solid solution of copper in an anode active material (for example, refer to Japanese Unexamined Patent Application Publication No. 2002-289177) and the like have been proposed. In addition, as a related art, a sputtering equipment including two sputtering sources in which plasma regions are overlapped with each other to use two types of elements as an anode active material has been known (for example, refer to Japanese Unexamined Patent Application Publication No. 2003-007291).

The recent portable electronic devices increasingly tend to become small, and the high performance and the multi functions thereof tend to be increasingly developed. Accordingly, there is a tendency that charge and discharge of the secondary battery are frequently repeated, and thus the cycle characteristics are easily lowered. In particular, in the lithium ion secondary battery in which silicon is used as an anode active material to attain a high capacity, the cycle characteristics are easily lowered significantly, being influenced by pulverization of the anode active material layer at the time of the foregoing charge and discharge. Thus, further improvement of the cycle characteristics of the secondary battery is aspired.

It is desirable to provide an anode with which the cycle characteristics are able to be improved and a battery including the same.

### SUMMARY

According to an embodiment, there is provided an anode having an anode active material layer including a multilayer structure of an anode active material containing silicon as an element on an anode current collector, wherein a thickness of each layer in the multilayer structure is from 50 nm to 1050 nm both inclusive. According to an embodiment, there is provided a secondary battery including a cathode, the anode of the foregoing embodiment, and an electrolyte.

In the anode and the secondary battery of the embodiments, the thickness of each layer in the multilayer structure included in the anode active material layer is from 50 nm to 1050 nm both inclusive. Thus, contact characteristics between each layer, contact characteristics between the anode active material layer and the anode current collector, and current collectivity are improved.

According to the anode of the embodiment, in the anode active material layer having the multilayer structure containing silicon, each layer has a thickness in a given range. Thus, contact characteristics between each layer, stress relaxation performance in the anode active material layer, contact characteristics between the anode active material layer and the anode current collector, and current collectivity are improved. In the result, pulverization, separation, and dropping of the anode active material layer associated with repetition of charge and discharge are able to be inhibited. Accordingly, while a high capacity is realized by using silicon as an anode active material, the cycle characteristics are also able to be improved.

Other and further objects, features and advantages of the invention will appear more fully from the following description.

Additional features and advantages are described herein, and will be apparent from the following Detailed Description and the figures.

### BRIEF DESCRIPTION OF THE FIGURES

FIG. 1 is a cross sectional view illustrating a structure of an anode as a first embodiment;

FIG. 2 is a cross sectional view illustrating a structure of an anode as a second embodiment;

FIG. 3 is a cross sectional view illustrating a structure of an anode as a third embodiment;

FIG. 4 is a cross sectional view illustrating a structure of a first secondary battery as a fourth embodiment;

FIG. 5 is a cross sectional view taken along line V-V of the first secondary battery illustrated in FIG. 4;

FIG. 6 is a cross sectional view illustrating a structure of a second secondary battery as a fourth embodiment;

FIG. 7 is a cross sectional view illustrating an enlarged part of the spirally wound electrode body illustrated in FIG. 6;

FIG. 8 is a cross sectional view illustrating a structure of a third secondary battery as a fourth embodiment;

FIG. 9 is a cross sectional view taken along line IX-IX of the spirally wound electrode body illustrated in FIG. 8;

FIG. 10 is a cross sectional view illustrating a structure of a secondary battery fabricated in examples;

FIG. 11 is a characteristics diagram illustrating a relation between a film thickness per one layer of a multilayer structure composing an anode active material layer and a discharge capacity retention ratio in Examples 1-1 to 1-16 and 2-1 to 2-16;

FIG. 12 is a characteristics diagram illustrating a relation between a film thickness per one layer of a multilayer structure composing an anode active material layer and a discharge capacity retention ratio in Examples 3-1 to 1-14;

FIG. 13 is a characteristics diagram illustrating a relation between a film thickness per one layer of a multilayer structure composing an anode active material layer and a discharge capacity retention ratio in Examples 4-1 to 4-12;

FIG. 14 is a characteristics diagram illustrating a relation between a film thickness per one layer of a multilayer structure composing an anode active material layer and a discharge capacity retention ratio in Examples 4-13 to 4-18 and 5-1 to 5-24;

FIG. 15 is a characteristics diagram illustrating a relation between a content ratio of oxygen in an anode active material and a discharge capacity retention ratio in Examples 6-1 to 6-5;

FIG. 16 is a characteristics diagram illustrating a relation between a surface roughness of an anode current collector and a discharge capacity retention ratio in Examples 7-1 to 7-6;

FIG. 17 is a characteristics diagram illustrating a relation between a film thickness per one layer of a multilayer structure composing an anode active material layer and a discharge capacity retention ratio in Examples 8-1 to 8-7;

FIG. 18 is a characteristics diagram illustrating a relation between a film thickness per one layer of a multilayer structure composing an anode active material layer and a discharge capacity retention ratio in Examples 11-17 to 11-21; and

FIG. 19 is a characteristics diagram illustrating a relation between a film thickness per one layer of a multilayer structure composing an anode active material layer and a discharge capacity retention ratio in Examples 14-17 to 14-16.

### DETAILED DESCRIPTION

Preferred embodiments (hereinafter referred to as embodiment) will be hereinafter described in detail with reference to the drawings. The description will be given in the following order.

1. First embodiment (anode: example that an anode active material layer is not particulate)

2. Second embodiment (anode: example that an anode active material layer is particulate)

3. Third embodiment (anode: example that an anode active material layer is particulate, and the surface or the like thereof has a metal)

4. Fourth embodiment (examples of a first secondary battery to a third secondary battery including the foregoing anodes)

### First Embodiment

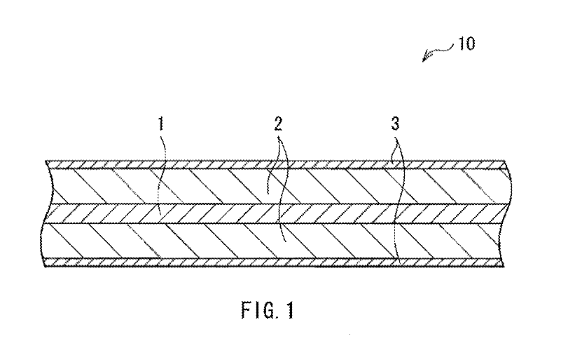

FIG. 1 illustrates a cross sectional structure of an anode 10 as a first embodiment. The anode 10 is used for an electrochemical device such as a battery. The anode has, for example, a structure in which an anode active material layer 2 and a compound layer 3 covering the surface thereof are sequentially provided on an anode current collector 1. The anode active material layer 2 and the compound layer 3 may be provided on both faces of the anode current collector 1, or may be provided only on a single face of the anode current collector 1.

The anode current collector 1 is preferably made of a metal material having favorable electrochemical stability, favorable electric conductivity, and favorable mechanical strength. Examples of the metal materials include copper (Cu), nickel (Ni), and stainless. Specially, copper is preferable as the metal material, since a high electric conductivity is able to be thereby obtained.

In particular, the metal material composing the anode current collector 1 preferably contains one or more metal elements not forming an intermetallic oxide with an electrode reactant. If the intermetallic oxide is formed with the electrode reactant, lowering of the current collectivity characteristics and separation of the anode active material layer 2 from the anode current collector 1 may occur, since the anode current collector 1 is broken by being affected by a stress due to expansion and shrinkage of the anode active material layer 2 at the time of charge and discharge. Examples of the metal elements include copper, nickel, titanium (Ti), iron (Fe), and chromium (Cr).

Further, the foregoing metal material preferably contains one or more metal elements being alloyed with the anode active material layer 2. Thereby, the contact characteristics between the anode current collector 1 and the anode active material layer 2 are improved, and thus the anode active material layer 2 is hardly separated from the anode current collector 1. For example, in the case that the anode active material of the anode active material layer 2 contains silicon (Si), examples of metal elements that do not form an intermetallic oxide with the electrode reactant and are alloyed with the anode active material layer 2 include copper, nickel, and iron. These metal elements are preferable in view of the strength and the electric conductivity as well.

The anode current collector 1 may have a single layer structure or a multilayer structure. In the case where the anode current collector 1 has the multilayer structure, for example, it is preferable that the layer adjacent to the anode active material layer 2 is made of a metal material being alloyed with the anode active material layer 2, and layers not adjacent to the anode active material layer 2 are made of other metal material.

The surface of the anode current collector 1 is preferably roughened. Thereby, due to the so-called anchor effect, the contact characteristics between the anode current collector 1 and the anode active material layer 2 are improved. In this case, it is enough that at least the surface of the anode current collector 1 opposed to the anode active material layer 2 is roughened. Examples of roughening methods include a method of forming fine particles by electrolytic treatment. The electrolytic treatment is a method of providing concavity and convexity by forming fine particles on the surface of the anode current collector 1 by electrolytic method in an electrolytic bath. A copper foil provided with the electrolytic treatment is generally called “electrolytic copper foil.”

Ten point height of roughness profile Rz of the surface of the anode current collector 1 is, for example, preferably from 1.5 μm to 6.5 μm both inclusive, since thereby the contact characteristics between the anode current collector 1 and the anode active material layer 2 are further improved.

The anode active material layer 2 contains an anode active material, and may also contain a binder, an electrical conductor or the like according to needs.

The anode active material contains, as an element, silicon (Si) as an anode material capable of inserting and extracting the electrode reactant. Silicon has a high ability to insert and extract lithium, and thereby a high energy density is able to be thereby obtained. Such an anode material may be a simple substance, an alloy, or a compound of silicon, or may have one or more phases thereof at least in part. Such a material may be used singly, or a plurality thereof may be used by mixture. In the invention, “the alloy” includes an alloy containing one or more metal elements and one or more metalloid elements, in addition to an alloy composed of two or more metal elements. The alloy may contain a nonmetallic element. The texture thereof includes a solid solution, a eutectic crystal (eutectic mixture), an intermetallic compound, and a texture in which two or more thereof coexist.

Examples of alloys of silicon include an alloy containing at least one selected from the group consisting of tin (Sn), nickel, copper, iron, cobalt (Co), manganese (Mn), zinc (Zn), indium (In), silver (Ag), titanium, germanium (Ge), bismuth (Bi), antimony (Sb), arsenic (As), magnesium (Mg), calcium (Ca), aluminum (Al), and chromium as the second element other than silicon. In particular, by adding an appropriate quantity of iron, cobalt, nickel, germanium, tin, arsenic, zinc, copper, titanium, chromium, magnesium, calcium, aluminum, or silver as the second element to the anode active material, the energy density may be improved compared to the case of using an anode active material composed of a silicon simple substance. In the case where the second element with which the energy density may be improved is contained, for example, at a ratio from 1.0 atomic % (at %) to 40 atomic % both inclusive out of the anode active material, contribution to improving the discharge capacity retention ratio as a secondary battery is clearly shown.

Examples of compounds of silicon include a compound having oxygen (O) or carbon (C) as an element other than silicon. The compound of silicon may contain, for example, one or a plurality of the foregoing second elements as an element other than silicon.

The anode active material preferably further has oxygen as an element, since thereby expansion and shrinkage of the anode active material layer 2 are inhibited. In the anode active material layer 2, at least part of oxygen is preferably bonded with part of silicon. In this case, the bonding state may be in the form of silicon monoxide, silicon dioxide, or in the form of other metastable state.

The content ratio of oxygen in the anode active material is preferably from 3 atomic % to 40 atomic % both inclusive, since thereby higher effects are able to be obtained. Specifically, if the content ratio of oxygen is smaller than 3 atomic %, expansion and shrinkage of the anode active material layer 2 are not sufficiently inhibited. Meanwhile, if the content ratio of oxygen is larger than 40 atomic %, the resistance is excessively increased. For example, in the case where the anode is used for a battery, the anode active material layer 2 does not include a coat formed by decomposition of the electrolytic solution and the like. That is, in the case where the content ratio of oxygen in the anode active material layer 2 is calculated, oxygen in the foregoing coat is not included in the calculation.

The anode active material layer 2 in which the anode active material has oxygen as an element is able to be formed by, for example, continuously introducing oxygen gas into a chamber when the anode active material is deposited by vapor-phase deposition method. In particular, in the case where a desired oxygen content is not able to be obtained only by introducing the oxygen gas, a liquid (for example, moisture vapor or the like) may be introduced into the chamber as a supply source of oxygen.

Further, the anode active material preferably further has at least one metal element selected from the group consisting of iron, cobalt, nickel, titanium, chromium, and molybdenum (Mo). Thereby, expansion and shrinkage of the anode active material layer 2 are inhibited

The content ratio of the metal element in the anode active material is preferably from 3 atomic % to 30 atomic % both inclusive, since thereby higher effect is obtained. More specifically, if the metal element content is smaller than 3 atomic %, expansion and shrinkage of the anode active material layer 2 are not sufficiently inhibited. Meanwhile, if the metal element content is larger than 30 atomic %, it is not practical since in such a case, the thickness of the anode active material layer 2 is excessively increased to obtain a desired battery capacity. If the thickness of the anode active material layer 2 is excessively increased, it is not practical since thereby separation of the anode active material layer 2 from the anode current collector 1 and break of the anode active material layer 2 may be easily caused.

The anode active material layer 2 in which the anode active material has the metal element as an element is able to be formed by, for example, using an evaporation source mixed with the metal element or using multiple evaporation sources when the anode active material is deposited by evaporation method as vapor-phase deposition method.

The anode active material layer 2 is formed by, for example, using coating method, vapor-phase deposition method, liquid-phase deposition method, spraying method, firing method, or a combination of two or more of these methods. In this case, in particular, the anode active material layer 2 is preferably formed by using vapor-phase deposition method, and the anode active material layer 2 and the anode current collector 1 are preferably alloyed in at least part of the interface thereof. Specifically, at the interface thereof, the element of the anode current collector 1 may be diffused in the anode active material layer 2; or the element of the anode active material layer 2 may be diffused in the anode current collector 1; or these elements may be diffused in each other. Thereby, breakage of the anode active material layer 2 due to expansion and shrinkage at the time of charge and discharge hardly occurs, and the electron conductivity between the anode current collector 1 and the anode active material layer 2 is improved.

Examples of vapor-phase deposition method include physical deposition method and chemical deposition method. More specific examples include vacuum evaporation method, sputtering method, ion plating method, laser ablation method, thermal CVD (Chemical Vapor Deposition) method, plasma CVD method, and spraying method. As liquid-phase deposition method, a known technique such as electrolytic plating and electroless plating is able to be used. Firing method is, for example, a method in which a particulate anode active material mixed with a binder or the like is dispersed in a solvent and the anode current collector is coated with the resultant, and then heat treatment is provided at temperature higher than the melting point of the binder or the like. Examples of firing method include a known technique such as atmosphere firing method, reactive firing method, and hot press firing method.

The anode active material layer 2 has a multilayer structure formed by forming layers containing the anode active material a plurality of times. The thickness of each layer in the multilayer structure is desirably from 50 nm to 1050 nm both inclusive, and in particular, is desirably from 100 nm to 700 nm both inclusive. By dividing the anode active material layer 2 into the plurality of layers and setting the thickness of each layer to a value within the foregoing range, an internal stress of the anode active material layer resulting from expansion and shrinkage of the anode active material at the time of charge and discharge is more easily relaxed. Further, in the case where the deposition step of the anode active material layer 2 is divided into a plurality of times (the anode active material layer 2 is sequentially formed and layered) in forming the anode active material layer 2 by using evaporation method or the like associated with high heat in deposition, the following advantage is obtained. That is, compared to a case that the anode active material layer 2 having a single layer structure is formed in one time deposition treatment, time that the anode current collector 1 is exposed at high heat is able to be shortened, and thermal damage to the anode current collector 1 is able to be decreased. However, in the case where the thickness of each layer exceeds 1000 nm, time that the anode current collector 1 is exposed at high heat is not able to be shortened much, and thermal damage to the anode current collector 1 is hardly avoided. Further, function of relaxing a stress is hardly obtained. Meanwhile, in the case where the thickness of each layer is under 50 nm, though thermal damage is easily avoided, stable film quality is hardly obtained. In addition, if the anode is used for an electrochemical device such as a secondary battery, there is concern that as the whole anode active material layer 2, the contact area with the electrolytic solution is increased, and thereby decomposition of the electrolytic solution associated with repetition of charge and discharge is easily promoted.

It is preferable that the anode active material layer 2 further has an oxygen-containing region in which the anode active material has oxygen in the thickness direction, and the content ratio of oxygen in the oxygen-containing region is larger than the content ratio of oxygen in the other regions. Thereby, expansion and shrinkage of the anode active material layer 2 are inhibited. It is possible that the regions other than the oxygen-containing region have oxygen or do not have oxygen. It is needless to say that in the case where the regions other than the oxygen-containing region also has oxygen as an element, the content ratio of oxygen thereof is lower than the content ratio of oxygen in the oxygen-containing region.

In this case, to further inhibit expansion and shrinkage of the anode active material layer 2, it is preferable that the regions other than the oxygen-containing region also have oxygen, that is, the anode active material layer 2 includes a first oxygen-containing region (region having the lower content ratio of oxygen) and a second oxygen-containing region having the higher content ratio of oxygen than that of the first oxygen-containing region (region having the higher content ratio of oxygen). In particular, it is preferable that the second oxygen-containing region is sandwiched between the first oxygen-containing regions. It is more preferable that the first oxygen-containing region and the second oxygen-containing region are alternately and repeatedly layered. Thereby, higher effects are able to be obtained. The content ratio of oxygen in the first oxygen-containing region is preferably small as much as possible. The content ratio of oxygen in the second oxygen-containing region is, for example, similar to the content ratio of oxygen in the case that the anode active material has oxygen as an element described above.

The anode active material layer 2 including the first oxygen-containing region and the second oxygen-containing region is able to be formed, for example, by intermittently introducing oxygen gas into a chamber in depositing the anode active material by using vapor-phase deposition method. It is needless to say that in the case where a desired content ratio of oxygen is not able to be obtained only by introducing the oxygen gas, liquid (for example, moisture vapor or the like) may be introduced into the chamber.

It is possible that the content ratio of oxygen of the first oxygen-containing layer is clearly different from the content ratio of oxygen of the second oxygen-containing layer, or the content ratio of oxygen of the first oxygen-containing layer is not clearly different from the content ratio of oxygen of the second oxygen-containing layer. That is, in the case where the introduction amount of the foregoing oxygen gas is continuously changed, the content ratio of oxygen may be continuously changed. In this case, the first oxygen-containing layer and the second oxygen-containing layer become “lamellar state” rather than “layers,” and the content ratio of oxygen in the anode active material layer 2 is distributed in a state of ups and downs in the thickness direction. In particular, it is preferable that the content ratio of oxygen is incrementally or continuously changed between the first oxygen-containing layer and the second oxygen-containing layer. In the case where the content ratio of oxygen is changed drastically, the ion diffusion characteristics may be lowered, or the resistance may be increased.

On the surface of the anode active material layer 2, the compound layer 3 containing silicon oxide is provided. The compound layer 3 is formed by, for example, after mentioned polysilazane treatment, liquid-phase deposition method, solgel method or the like, and may have Si—N bond in addition to Si—O bond. Thereby, in the case where the anode is used for an electrochemical device such as a secondary battery, the chemical stability of the anode 10 is able to be improved, and the charge and discharge efficiency is able to be improved by inhibiting decomposition of the electrolytic solution. It is enough the compound layer 3 covers at least part of the surface of the anode active material layer 2, but the compound layer 3 desirably covers a wide range of the anode active material layer 2 as much as possible in order to sufficiently improve the chemical stability. Further, the compound layer 3 may further have Si—C bond. Thereby, the chemical stability of the anode 10 is able to be sufficiently improved.

The thickness of the compound layer 3 is, for example, preferably from 10 nm to 1000 nm both inclusive. If the thickness of the compound layer 3 is 10 nm or more, the compound layer 3 is able to sufficiently cover the anode active material layer 2, and thus decomposition of the electrolytic solution is able to be effectively inhibited. Further, if the thickness of the compound layer 3 is 1000 nm or less, it becomes advantageous to inhibiting resistance increase and preventing lowering of the energy density.

Examples of measurement methods for examining bonding state of elements include X-ray Photoelectron Spectroscopy (XPS). In XPS, in the apparatus in which energy calibration is made so that the peak of 4f orbit of gold atom (Au4f) is obtained in 84.0 eV, for respective peaks of 2p orbit of silicon bonded with oxygen (Si2p_{1/2}Si—O and Si2p_{3/2}Si—O), the peak of Si2p_{1/2}Si—O is shown in 104.0 eV peak of Si2p_{3/2}Si—O is shown in 103.4 eV. Meanwhile, for respective peaks of 2p orbit of silicon bonded with nitrogen (Si2p_{1/2}Si—N and Si2p_{3/2}Si—N), the respective peaks are shown in a lower region than that of the 2p orbit of silicon bonded with oxygen (Si2p_{1/2}Si—O and Si2p_{3/2}Si—O). Further, in the case of having Si—C bond, for respective peaks of 2p orbit of silicon bonded with carbon (Si2p_{1/2}Si—C and Si2p_{3/2}Si—C), the respective peaks are shown in a lower region than that of the 2p orbit of silicon bonded with oxygen (Si2p_{1/2}Si—O and Si2p_{3/2}Si—O).

The anode 10 is formed, for example, by the following procedure. Specifically, first, the anode current collector 1 is prepared, and the surface of the anode current collector 1 is provided with roughening treatment according to needs. After that, the layers containing the foregoing anode active material are deposited a plurality of times on the surface of the anode current collector 1 by using the foregoing method such as vapor-phase deposition method to form the anode active material layer 2 having a multilayer structure. If vapor-phase deposition method is used, the anode active material may be deposited while the anode current collector 1 is fixed, or the anode active material may be deposited while the anode current collector 1 is rotated. Further, the compound layer 3 having Si—O bond and Si—N bond is formed by liquid-phase deposition method or vapor-phase deposition method so that at least part of the surface of the anode active material layer 2 is covered therewith. Thereby, the anode is formed.

The compound layer 3 is formed by, for example, polysilazane treatment in which the anode active material and a solution containing a silazane system compound are reacted. Si—O bond is generated by reaction between part of the silazane system compound and moisture in the air or the like. Meanwhile, Si—N bond is formed by reaction between silicon composing the anode active material layer 2 and the silazane system compound, or otherwise may be also generated by reaction between part of the silazane system compound and moisture in the air. As the silazane system compound, for example, perhydropolysilazane (PHPS) may be used. Perhydropolysilazane is an inorganic polymer with —(SiH₂NH)— as a basic unit, and is soluble in an organic solvent. Further, in forming the compound layer 3, for example, a solution containing silylisocyanate system compound may be used similarly to the solution containing the silazane system compound. Examples of silylisocyanate system compound include tetraisocyanate silane (Si(NCO)₄) and methyl triisocyanate silane (Si(CH₃)(NCO)₃). In the case where a compound having Si—C bond such as methyl triisocyanate silane (Si(CH₃)(NCO)₃) is used, the compound layer 3 further has Si—C bond. The compound layer 3 may be formed by liquid-phase deposition method. Specifically, for example, a dissolved species that easily coordinates fluorine (F) as an anion capture agent is added to a silicon fluoride complex solution, and the resultant is mixed to obtain a mixed solution. After that, the anode current collector 1 on which the anode active material layer 2 is formed is dipped into the mixed solution, and fluorine anion generated from the fluoride complex is captured by the dissolved species. Thereby an oxide is precipitated on the surface of the anode active material layer 2 and an oxide-containing film as the compound layer 3 is formed. Instead of the fluoride complex, for example, a silicon compound, a tin compound, or a germanium compound that generates other anion such as sulfate ion may be used. Further, the compound layer 3 is able to be formed by solgel method. In this case, a treatment liquid containing fluorine anion or a compound of fluorine and one of elements from Group 13 to Group 15 (specifically, fluorine ion, tetrafluoroborate ion, hexafluorophosphate ion or the like) as a reaction accelerator is used to form an oxide-containing film as the compound layer 3.

As described above, according to the anode 10 of this embodiment, the anode active material layer 2 has the multilayer structure, and each layer has a thickness in a given range. Thus, contact characteristics between each layer, contact characteristics between the anode active material layer 2 and the anode current collector 1, and current collectivity are improved. Therefore, in the case where the anode is used for an electrochemical device such as a secondary battery, pulverization, separation, and dropping of the anode active material layer 2 associated with charge and discharge are able to be inhibited. Accordingly, while a high capacity is realized by using silicon as an anode active material, the cycle characteristics are also able to be improved.

Further, in the anode 10, the compound layer 3 having Si—O bond and Si—N bond is provided at least in part of the surface of the anode active material layer 2. Thus, chemical stability of the anode 10 is able to be improved. Therefore, decomposition reaction of the electrolytic solution is able to be inhibited, and charge and discharge efficiency is able to be improved. In particular, in the case where the compound layer 3 having Si—O bond and Si—N bond is formed by liquid-phase deposition method, compared to a case of using vapor-phase deposition method, the surface of the anode active material layer 2 contacted with the electrolytic solution is able to be covered with more homogenized compound layer 3, and thereby the chemical stability of the anode 10 is able to be further improved.

Further, in the case where the anode active material further has oxygen as an element and the oxygen content in the anode active material is in the range from 3 atomic % to 40 atomic %, higher effect is able to be obtained. The effect is similarly obtained in the case that the anode active material layer 2 has the oxygen-containing layer (layer in which the anode active material further has oxygen as an element and the oxygen content is higher than that of the other layers) in the thickness direction.

Further, in the case where the anode active material further has at least one metal element selected from the group consisting of iron, cobalt, nickel, titanium, chromium, and molybdenum, and the metal element content in the anode active material is in the range from 3 atomic % to 30 atomic %, higher effect is able to be obtained.

Further, in the case where the surface of the anode current collector 1 opposed to the anode active material layer 2 is roughened by the fine particle formed by electrolytic treatment, the contact characteristics between the anode current collector 1 and the anode active material layer 2 are able to be improved. In this case, in the case where the ten point height of roughness profile Rz of the surface of the anode current collector 1 is in the range from 1.5 μm to 6.5 μm, higher effect is able to be obtained.

### Second Embodiment

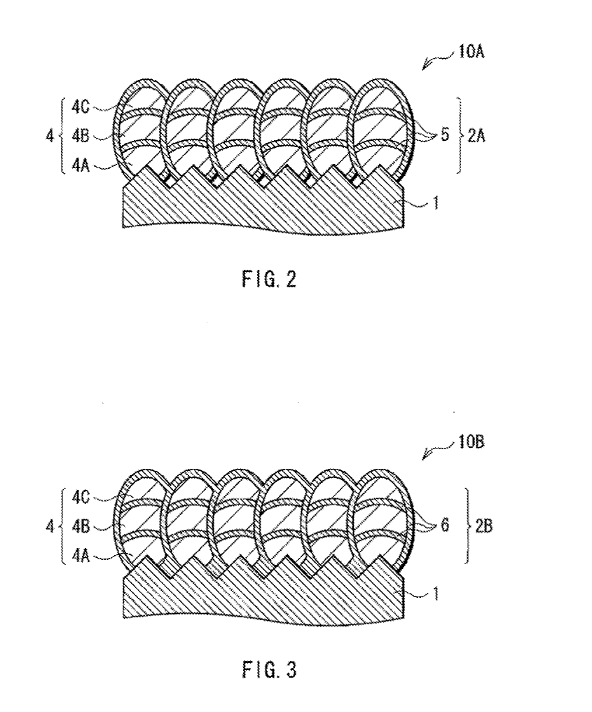

FIG. 2 schematically illustrates a cross sectional structure of a main section of an anode 10A as a second embodiment of the invention. The anode 10A is used, for example, for an electrochemical device such as a battery as the anode 10 of the foregoing first embodiment is. In the following description, structures, actions, and effects of the elements substantially identical with those of the foregoing anode 10 will be omitted.

As illustrated in FIG. 2, the anode 10A has a structure in which an anode active material layer 2A containing a plurality of anode active material particles 4 is provided on the anode current collector 1. The respective anode active material particles 4 have a multilayer structure in which a plurality of layers 4A to 4C composed of an anode active material similar to that of the first embodiment are layered. The multilayer structure extends in the thickness direction of the anode active material particles 4 so that the multilayer structure stands on the anode current collector 1. The thickness of the layers 4A to 4C is desirably from 50 nm to 1050 nm both inclusive respectively. In particular, the thickness of the layers 4A to 4C is desirably from 100 nm to 700 nm both inclusive. On the surface of the anode active material particles 4, a compound layer 5 having Si—O bond and Si—N bond is formed. It is enough that the compound layer 5 covers at least part of the surface of the anode active material particles 4, for example, a region contacted with an electrolytic solution out of the surface of the anode active material particles 4 (that is, a region other than regions contacted with the anode current collector 1, a binder, or other anode active material particles 4). However, to further secure chemical stability of the anode 10A, the compound layer 5 desirably covers a wide range of the surface of the anode active material particles 4 as much as possible. In particular, as illustrated in FIG. 2, the compound layer 5 desirably covers the entire surface of the anode active material particles 4. Further, the compound layer 5 is desirably provided in at least part of the interface between the plurality of layers 4A to 4C. In particular, as illustrated in FIG. 2, the compound layer 5 desirably covers the all interlayers in between. The anode active material layer 2A and the compound layer 5 may be provided on both faces of the anode current collector 1, or may be provided on only one face thereof.

The anode active material particles 4 are formed by, for example, one of vapor-phase deposition method, liquid-phase deposition method, spraying method, and firing method, or two or more methods thereof as in the foregoing first embodiment. In particular, vapor-phase deposition method is preferably used, since thereby the anode current collector 1 and the anode active material particles 4 are easily alloyed in the interface thereof. Alloying may be made by diffusing an element of the anode current collector 1 into the anode active material particles 4; or vice versa. Otherwise, alloying may be made by diffusion of the element of the anode current collector 1 and silicon as an element of the anode active material particles 4 into each other. Due to such alloying, structural breakage of the anode active material particles 4 resulting from expansion and shrinkage at the time of charge and discharge is inhibited, and the electric conductivity between the anode current collector 1 and the anode active material particles 4 is improved.

Further, to inhibit expansion and shrinkage of the anode active material layer 2A, the respective anode active material particles 4 preferably contain a first oxygen-containing layer and a second oxygen-containing layer having a content ratio of oxygen different from each other as in the first embodiment. In this case, it is particularly preferable that the first oxygen-containing layer and the second oxygen-containing layer are alternately layered repeatedly. For example, it is preferable that the layers 4A and 4C are the first oxygen-containing layer, and the layer 4B is the second oxygen-containing layer.

As described above, in this embodiment, the anode active material particles 4 containing silicon provided on the anode current collector 1 are formed as the multilayer structure, and the respective layers 4A to 4C have a thickness in a given range. Thus, contact characteristics between each layer, contact characteristics between the anode active material layer 2A and the anode current collector 1, and current collectivity are improved. Therefore, effect similar to that of the foregoing first embodiment is able to be obtained.

Further, the compound layer 5 having Si—O bond and Si—N bond is provided in at least part of the surface of the anode active material particles 4 and in a portion between the respective layers 4A to 4C. Thus, the chemical stability of the anode 10A is able to be improved. Thus, effect similar to that of the foregoing first embodiment is able to be obtained.

### Third Embodiment

FIG. 3 schematically illustrates a cross sectional structure of a main section of an anode 10B as a third embodiment. The anode 10B is used, for example, for an electrochemical device such as a battery as the anodes 10 and 10A of the foregoing first and the foregoing second embodiments are. In the following description, structures, actions, and effects of the elements substantially identical with those of the foregoing anodes 10 and 10A will be omitted.

As illustrated in FIG. 3, the anode 10B includes an anode active material layer 2B containing the plurality of anode active material particles 4 and a metal 6 containing a metal element not being alloyed with an electrode reactant such as silicon on the anode current collector 1. Such a metal element includes at least one of iron, cobalt, nickel, zinc, and copper.

The anode active material layer 2B contains the metal 6. Thus, even in the case where the anode active material particles 4 are formed by vapor-phase deposition method or the like, the anode active material layer 2B has high bonding characteristics. Thus, a clearance between the plurality of anode active material particles 4 is preferably filled with the metal 6 densely. Thereby, the bonding characteristics between the anode active material particles 4 are further improved. Further, it is preferable the metal 6 also exists in a portion between the respective layers 4A to 4C in the anode active material particles 4. Further, a void inside the anode active material particles 4 is preferably filled with the metal 6. Thereby, the bonding characteristics in the anode active material particles 4 are further improved.

Further, the metal 6 is desirably provided to cover at least part of the exposed face of the anode active material particles 4 for the following reason. In particular, in the case where the anode active material particles 4 are formed by vapor-phase deposition method, a plurality of fibrous fine projection sections (not illustrated) are easily formed on the exposed face of the anode active material particles 4. The fibrous projection sections may adversely affect performance as an electrochemical device. Specifically, the fibrous projection sections cause increase of the surface area of the anode active material, and increases an irreversible coat formed on the surface thereof. Thus, the fibrous projection sections may be a cause to decrease progression degree of electrode reaction. Thus, to avoid lowering the progression degree of electrode reaction as above, the metal 6 is preferably provided to cover the fibrous projection sections on the exposed face of the anode active material particles 4 and a void thereabout. In this case, it is enough that the metal 6 exists so that at least part of the void between the fibrous projection sections is filled with the metal 6. However, the filling amount is preferably large as much as possible. Thereby, lowering the progression degree of electrode reaction is further inhibited.

The metal 6 is formed by at least one method selected from the group consisting of vapor-phase deposition method and liquid-phase deposition method. Specially, the metal 6 is preferably formed by liquid-phase deposition method. Thereby, the clearance between the anode active material particles 4, the clearance between the layers 4A to 4C, the inside of the anode active material particles 4, the void on the exposed face and the like are easily filled with the metal densely.

Examples of the foregoing vapor-phase deposition method include a method similar to the method of forming the anode active material particles. Further, examples of liquid-phase deposition method include plating method such as electrolytic plating method and electroless plating method.

The ratio (molar ratio) M2/M1 between the number of moles M1 per unit area of the anode active material particles 4 and the number of moles M2 per unit area of the metal is preferably from 0.01 to 1 both inclusive. Thereby, expansion and shrinkage of the anode active material layer 2B are inhibited. The occupancy ratio of the metal is able to be measured by providing element analysis for the surface of the anode with the use of energy dispersive x-ray fluorescence spectroscopy (EDX).

In particular, the metal 6 preferably further has oxygen, since thereby expansion and shrinkage of the anode active material layer 2B are inhibited. The content ratio of oxygen in the metal 6 is preferably in the range from 1.5 atomic % to 30 atomic %, since thereby higher effect is obtained. More specifically, if the content ratio of oxygen is smaller than 1.5 atomic %, expansion and shrinkage of the anode active material layer 2B are not sufficiently inhibited. Meanwhile, if the content ratio of oxygen is larger than 30 atomic %, the resistance is excessively increased. The metal 6 having oxygen is able to be formed by, for example, a procedure similar to that of the anode active material particles 4 having oxygen.

The anode 10B is manufactured by, for example, the following procedure.

First, the anode current collector 1 is prepared. Roughening treatment is provided for the surface thereof according to needs. After that, the plurality of anode active material particles 4 having silicon are formed on the anode current collector 1 by vapor-phase deposition method or the like. At this time, the anode active material particles 4 are formed as a multilayer structure by a plurality of deposition treatments. After that, the metal 6 having the foregoing metal element is formed by liquid-phase deposition method or the like. That is, the metal 6 is injected into a clearance between adjacent anode active material particles 4, at least part of the exposed face of the anode active material particles 4 is covered with the metal 6, and the metal 6 is injected into a portion between each layer of the anode active material particles 4 and a void inside the anode active material particles 4. In the result, the anode active material layer 2B is formed.

According to the anode 10B of this embodiment, after the anode active material particles 4 having a multilayer structure are formed on the anode current collector 1, the metal 6 having the metal element not being alloyed with the electrode reactant is provided in a clearance between adjacent anode active material particles 4. Thus, the following effect is able to be obtained. That is, the anode active material particles 4 are bonded with the metal 6 in between, and thereby the anode active material layer 2B is more hardly pulverized or dropped. Therefore, in an electrochemical device using the anode 10B, the cycle characteristics are able to be further improved.

In particular, in the case where the metal 6 covers at least part of the exposed face of the anode active material particles 4, adverse effect of the fibrous fine projection portion generated on the exposed face is inhibited. Further, in the case where the metal 6 intrudes into a portion between the layers 4A to 4C of the anode active material particles 4, pulverization and dropping of the anode active material layer 2B are more effectively inhibited.

Further, in the case where the molar ratio M2/M1 between the anode active material particles 4 and the metal 6 is from 0.01 to 1 both inclusive, higher effect is able to be obtained.

Further, in the case where the anode active material particles 4 further have oxygen and the content ratio of oxygen in the anode active material is in the range from 3 atomic % to 40 atomic %, the anode active material particles 4 further have at least one metal element selected from the group consisting of iron, cobalt, nickel, titanium, chromium, and molybdenum, the anode active material particles 4 further have the oxygen-containing region (region in which the anode active material particles 4 further have oxygen and the oxygen content is higher than that of the other regions) in the thickness direction, or the metal further has oxygen and the content ratio of oxygen in the metal is in the range from 1.5 atomic % to 30 atomic %, higher effect is able to be obtained.

Further, in the case where the metal 6 is formed by liquid-phase deposition method, the metal 6 easily intrudes into a clearance between adjacent anode active material particles 4 and a void inside the anode active material particles 4, and the metal 6 is easily buried in a void between fibrous fine projection sections. Thus, higher effect is able to be obtained.

### Fourth Embodiment

Next, a description will be given of usage examples of the anodes 10, 10A, and 10B described in the foregoing first to the third embodiments. A description will be given, as an example, taking a first to a third secondary batteries as an electrochemical device. The foregoing anodes 10, 10A, and 10B are used for the first to the third secondary batteries as below.

First Secondary Battery

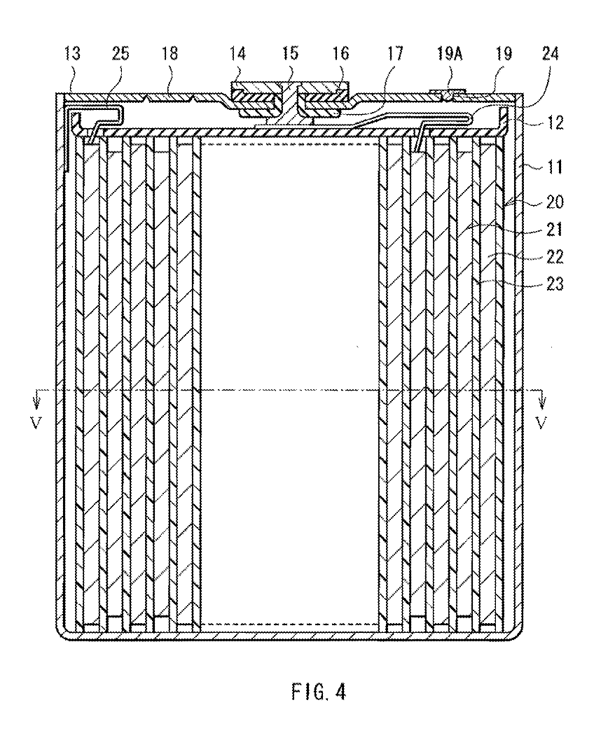

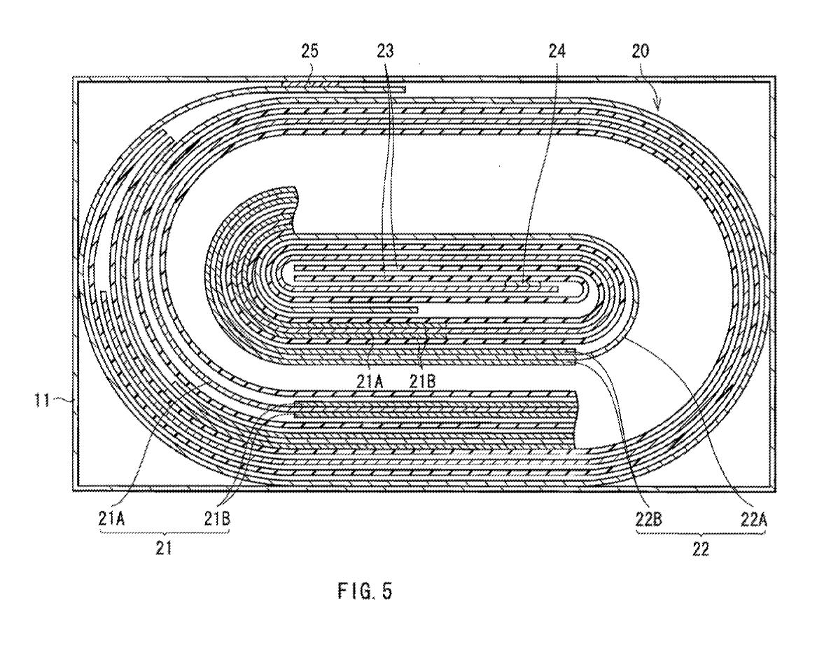

FIG. 4 and FIG. 5 illustrate a cross sectional structure of a first secondary battery. FIG. 5 illustrates a cross section taken along line V-V illustrated in FIG. 4. The secondary battery herein described is, for example, a lithium ion secondary battery in which the capacity of an anode 22 is expressed based on insertion and extraction of lithium as an electrode reactant.

The secondary battery mainly contains a battery element 20 having a planular spirally wound structure in a battery can 11.

The battery can 11 is, for example, a square package member. As illustrated in FIG. 5, the square package member has a shape with the cross section in the longitudinal direction of a rectangle or an approximate rectangle (including curved lines in part). The battery can 11 structures not only a square battery in the shape of a rectangle, but also a square battery in the shape of an oval. That is, the square package member means a rectangle vessel-like member with the bottom or an oval vessel-like member with the bottom, which respectively has an opening in the shape of a rectangle or in the shape of an approximate rectangle (oval shape) formed by connecting circular arcs by straight lines. FIG. 5 illustrates a case that the battery can 11 has a rectangular cross sectional shape. The battery structure including the battery can 11 is a so-called square type.

The battery can 11 is made of, for example, a metal material containing iron, aluminum, or an alloy thereof. The battery can 11 may have a function as an electrode terminal as well. In this case, to inhibit the secondary battery from being swollen by using the rigidity (hardly deformable characteristics) of the battery can 11 at the time of charge and discharge, the battery can 11 is preferably made of rigid iron than aluminum. In the case where the battery can 11 is made of iron, for example, the iron may be plated by nickel or the like.

The battery can 11 also has a hollow structure in which one end of the battery can 11 is closed and the other end of the battery can 11 is opened. At the open end of the battery can 11, an insulating plate 12 and a battery cover 13 are attached, and thereby inside of the battery can 11 is hermetically closed. The insulating plate 12 is located between the battery element 20 and the battery cover 13, is arranged perpendicularly to the spirally wound circumferential face of the battery element 20, and is made of, for example, polypropylene or the like. The battery cover 13 is, for example, made of a material similar to that of the battery can 11, and may also have a function as an electrode terminal as the battery can 11 does.

Outside of the battery cover 13, a terminal plate 14 as a cathode terminal is provided. The terminal plate 14 is electrically insulated from the battery cover 13 with an insulating case 16 in between. The insulating case 16 is made of, for example, polybutylene terephthalate or the like. In the approximate center of the battery cover 13, a through-hole is provided. A cathode pin 15 is inserted in the through-hole so that the cathode pin is electrically connected to the terminal plate 14 and is electrically insulated from the battery cover 13 with a gasket 17 in between. The gasket 17 is made of, for example, an insulating material, and the surface thereof is coated with asphalt.

In the vicinity of the rim of the battery cover 13, a splitting valve 18 and an injection hole 19 are provided. The splitting valve 18 is electrically connected to the battery cover 13. In the case where the internal pressure of the battery becomes a certain level or more by internal short circuit, external heating or the like, the splitting valve 18 is separated from the battery cover 13 to release the internal pressure. The injection hole 19 is sealed by a sealing member 19A made of, for example, a stainless steel ball.

The battery element 20 is formed by layering a cathode 21 and the anode 22 with a separator 23 in between and then spirally winding the resultant laminated body. The battery element 20 is planular according to the shape of the battery can 11. A cathode lead 24 made of a metal material such as aluminum is attached to an end of the cathode 21 (for example, the internal end thereof). An anode lead 25 made of a metal material such as nickel is attached to an end of the anode 22 (for example, the outer end thereof). The cathode lead 24 is electrically connected to the terminal plate 14 by being welded to an end of the cathode pin 15. The anode lead 25 is welded and electrically connected to the battery can 11.

In the cathode 21, for example, a cathode active material layer 21B is provided on both faces of a cathode current collector 21A having a pair of faces. However, the cathode active material layer 21B may be provided only on a single face of the cathode current collector 21A.

The cathode current collector 21A is made of, for example, a metal material such as aluminum, nickel, and stainless.

The cathode active material layer 21B contains, as a cathode active material, one or more cathode materials capable of inserting and extracting lithium. According to needs, the cathode active material layer 21B may contain other material such as a cathode binder and a cathode electrical conductor.

As the cathode material capable of inserting and extracting lithium, for example, a lithium-containing compound is preferable, since thereby a high energy density is able to be obtained. Examples of the lithium-containing compound include a complex oxide containing lithium and a transition metal element, and a phosphate compound containing lithium and a transition metal element. Specially, a compound containing at least one selected from the group consisting of cobalt, nickel, manganese, and iron as a transition metal element is preferable, since thereby a higher voltage is able to be obtained. The chemical formula thereof is expressed by, for example, LiₓM1O₂ or Li_{y}M2PO₄. In the formula, M1 and M2 represent one or more transition metal elements. Values of x and y vary according to the charge and discharge state, and are generally in the range of 0.05≦x≦1.10 and 0.05≦y≦1.10.

Examples of complex oxides containing lithium and a transition metal element include a lithium cobalt complex oxide (LiₓCoO₂), a lithium nickel complex oxide (LiₓNiO₂), a lithium nickel cobalt complex oxide (LiₓNi_{1-z}CO_{z}O₂ (z<1)), a lithium nickel cobalt manganese complex oxide (LiₓNi_{(1-v-w)}COᵥMn_{w}O₂) (v+w<1)), and lithium manganese complex oxide having a spinel structure (LiMn₂O₄). Specially, a complex oxide containing cobalt is preferable, since thereby a high capacity is obtained and superior cycle characteristics are obtained. Further, examples of phosphate compounds containing lithium and a transition metal element include lithium iron phosphate compound (LiFePO₄) and a lithium iron manganese phosphate compound (LiFe₁₋ᵤMnᵤPO₄ (u<1)).

In addition, examples of cathode materials capable of inserting and extracting lithium include an oxide such as titanium oxide, vanadium oxide, and manganese dioxide; a disulfide such as titanium disulfide and molybdenum sulfide; a chalcogenide such as niobium selenide; sulfur; and a conductive polymer such as polyaniline and polythiophene.

The cathode material capable of inserting and extracting lithium may be a material other than the foregoing compounds. Further, two or more of the foregoing cathode materials may be used by mixture arbitrarily.

Examples of cathode binders include a synthetic rubber such as styrene-butadiene rubber, fluorine system rubber, and ethylene propylenediene, and a polymer material such as polyvinylidene fluoride. One thereof may be used singly, or a plurality thereof may be used by mixture.

Examples of cathode electrical conductors include a carbon material such as graphite, carbon black, acetylene black, and Ketjen black. One thereof may be used singly, or a plurality thereof may be used by mixture. The cathode electrical conductor may be a metal material, a conductive polymer or the like as long as the material has electric conductivity.

The anode 22 has a structure similar to one of the structures of the anodes 10, 10A, and 10B. For example, in the anode 22, an anode active material layer 22B or the like is provided on both faces of an anode current collector 22A. The structures of the anode current collector 22A and the anode active material layer 22B are respectively similar to the structures of the anode current collector 1 and the anode active material layer 2 (or 2A or 2B) in the foregoing anodes 10, 10A, and 10B. In the case where the anode 22 has a structure similar to that of the anode 10 or the anode 10A, the anode 22 further has the compound layer 3 or the compound layer 5. However, illustration thereof is omitted in FIG. 4 and FIG. 5. Similarly, in the case where the anode 22 has a structure similar to that of the anode 10B, though the anode active material layer 22B is further provided with the metal 6, illustration thereof is omitted in FIG. 4 and FIG. 5. In the anode 22, the chargeable capacity in the anode material capable of inserting and extracting lithium is preferably larger than the discharge capacity of the cathode 21.

The separator 23 separates the cathode 21 from the anode 22, and passes ions as an electrode reactant while preventing current short circuit due to contact of both electrodes. The separator 23 is made of, for example, a porous film composed of a synthetic resin such as polytetrafluoroethylene, polypropylene, and polyethylene, or a ceramic porous film. The separator 23 may have a structure in which two or more porous films as the foregoing porous films are layered.

An electrolytic solution as a liquid electrolyte is impregnated in the separator 23. The electrolytic solution contains a solvent and an electrolyte salt dissolved therein.

The solvent contains, for example, one or more nonaqueous solvents such as an organic solvent. The solvents described below may be combined arbitrarily.

Examples of nonaqueous solvents include ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, trimethylacetic acid methyl, trimethylacetic acid ethyl, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. Specially, at least one selected from the group consisting of ethylene carbonate, propylene carbonate, dimethyl carbonate, diethyl carbonate, and ethyl methyl carbonate is preferable. In this case, a mixture of a high viscosity (high dielectric constant) solvent (for example, specific inductive ε≧30) such as ethylene carbonate and propylene carbonate and a low viscosity solvent (for example, viscosity≦1 mPa·s) such as dimethyl carbonate, ethylmethyl carbonate, and diethyl carbonate is more preferable. Thereby, dissociation characteristics of the electrolyte salt and ion mobility are improved.

In particular, the solvent preferably contains at least one of a chain ester carbonate having halogen as an element illustrated in Chemical formula 1 and a cyclic ester carbonate having halogen as an element illustrated in Chemical formula 2. Thereby, a stable protective film is formed on the surface of the anode 22 at the time of charge and discharge, and decomposition reaction of the electrolytic solution is inhibited.

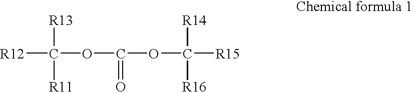

In the formula, R11 to R16 are a hydrogen group, a halogen group, an alkyl group, or an alkyl halide group. At least one of R11 to R16 is the halogen group or the alkyl halide group.

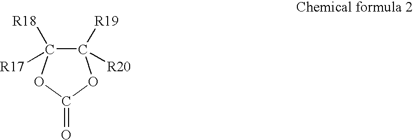

In the formula, R17 to R20 are a hydrogen group, a halogen group, an alkyl group, or an alkyl halide group. At least one of R17 to R20 is the halogen group or the alkyl halide group.

R11 to R16 in Chemical formula 1 may be identical or different. That is, types of R11 to R16 may be individually set in the range of the foregoing groups. The same is applied to R17 to R20 in Chemical formula 2.

The halogen type is not particularly limited, but fluorine, chlorine, or bromine is preferable, and fluorine is more preferable since thereby higher effect is obtained. Higher effect is thereby obtained compared to other halogen.

The number of halogen is more preferably two than one, and further may be three or more, since thereby an ability to form a protective film is improved, and a more rigid and stable protective film is formed. Accordingly, decomposition reaction of the electrolytic solution is further inhibited.

Examples of the chain ester carbonate having halogen shown in Chemical formula 1 include fluoromethyl methyl carbonate, bis(fluoromethyl)carbonate, and difluoromethyl methyl carbonate. One thereof may be used singly, or a plurality thereof may be used by mixture. Specially, bis(fluoromethyl)carbonate is preferable, since thereby high effect is obtained.

Examples of the cyclic ester carbonate having halogen shown in Chemical formula 2 include compounds shown in Chemical formulas 3(1) to 3(12) and Chemical formulas 4(1) to 4(9).

Chemical formula 3(1): 4-fluoro-1,3-dioxolane-2-one

Chemical formula 3(2): 4-chloro-1,3-dioxolane-2-one

Chemical formula 3(3): 4,5-difluoro-1,3-dioxolane-2-one

Chemical formula 3(4): tetrafluoro-1,3-dioxolane-2-one

Chemical formula 3(5): 4-chloro-5-fluoro-1,3-dioxolane-2-one

Chemical formula 3(6): 4,5-dichloro-1,3-dioxolane-2-one

Chemical formula 3(7): tetrachloro-1,3-dioxolane 2-one

Chemical formula 3(8): 4,5-bis trifluoro methyl-1,3-dioxolane 2-one

Chemical formula 3(9): 4-trifuloro methyl-1,3-dioxolane-2-one

Chemical formula 3(10): 4,5-difluoro-4,5-dimethyl-1,3-dioxolane-2-one

Chemical formula 3(11): 4,4-difluoro-5-methyl-1,3-dioxolane-2-one

Chemical formula 3(12): 4-ethyl-5,5-difluoro-1,3-dioxolane-2-one

Chemical formula 4(1): 4-fluoro-5-trifluoromethyl-1,3-dioxolane-2-one

Chemical formula 4(2): 4-methyl-5-trifluoromethyl-1,3-dioxolane-2-one

Chemical formula 4(3): 4-fluoro-4,5-dimethyl-1,3-dioxolane-2-one

Chemical formula 4(4): 5-(1,1-difluoroethyl)-4,4-difluoro-1,3-dioxolane-2-one

Chemical formula 4(5): 4,5-dichloro-4,5-dimethyl-1,3-dioxolane-2-one

Chemical formula 4(6): 4-ethyl-5-fluoro-1,3-dioxolane-2-one

Chemical formula 4(7): 4-ethyl-4,5-difluoro-1,3-dioxolane-2-one

Chemical formula 4(8): 4-ethyl-4,5,5-trifluoro-1,3-dioxolane-2-one

Chemical formula 4(9): 4-fluoro-4-methyl-1,3-dioxolane-2-one

One thereof may be used singly, or a plurality thereof may be used by mixture.

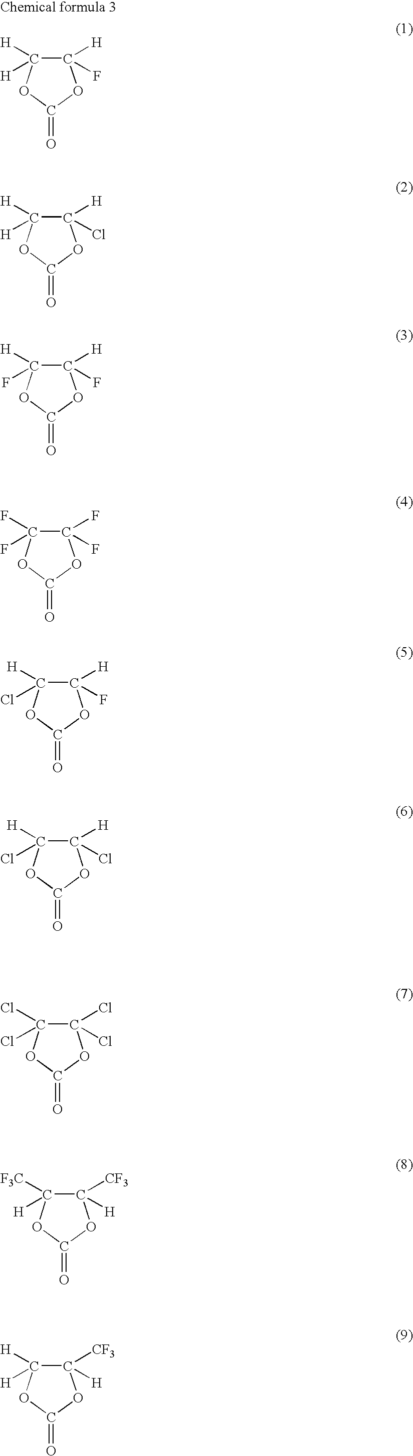

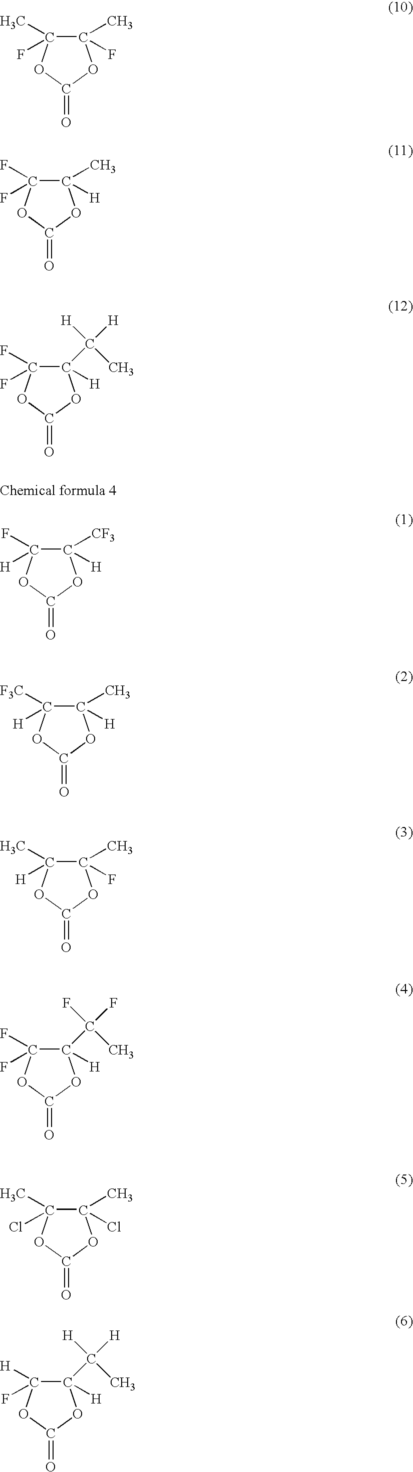

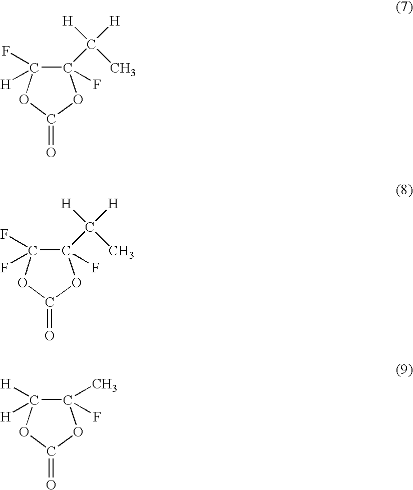

Specially, 4-fluoro-1,3-dioxolane-2-one of Chemical formula 3(1) or 4,5-difluoro-1,3-dioxolane-2-one of Chemical formula 3(3) is preferable, and 4,5-difluoro-1,3-dioxolane-2-one of Chemical formula 3(3) is more preferable. In particular, as 4,5-difluoro-1,3-dioxolane-2-one of Chemical formula 3(3), a trans isomer is more preferable than a cis isomer, since the trans isomer is easily available and provides high effect.

Further, the solvent preferably contains a cyclic ester carbonate having an unsaturated bond shown in Chemical formula 5 to Chemical formula 7. Thereby, the chemical stability of the electrolytic solution is further improved. One thereof may be used singly, or a plurality thereof may be used by mixture.

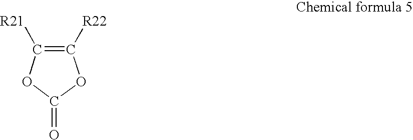

In the formula, R21 and R22 are a hydrogen group or an alkyl group.

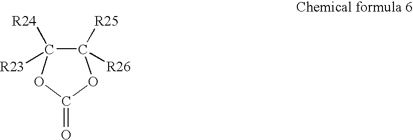

In the formula, R23 to R26 are a hydrogen group, an alkyl group, a vinyl group, or an aryl group. At least one of R23 to R26 is the vinyl group or the aryl group.

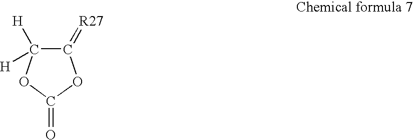

In the formula, R27 is an alkylene group.

The cyclic ester carbonate having an unsaturated bond shown in Chemical formula 5 is a vinylene carbonate compound. Examples of the vinylene carbonate compound include the following compounds:

vinylene carbonate(1,3-dioxole-2-one)

methylvinylene carbonate(4-methyl-1,3-dioxole-2-one)

ethylvinylene carbonate(4-ethyl-1,3-dioxole-2-one)

4,5-dimethyl-1,3-dioxole-2-one

4,5-diethyl-1,3-dioxole-2-one

4-fluoro-1,3-dioxole-2-one

4-trifluoromethyl-1,3-dioxole-2-one

Specially, vinylene carbonate is preferable, since vinylene carbonate is easily available and provides high effect.

The cyclic ester carbonate having an unsaturated bond shown in Chemical formula 6 is a vinylethylene carbonate compound. Examples of vinylethylene carbonate compounds include the following compounds:

vinylethylene carbonate(4-vinyl-1,3-dioxolane-2-one)

4-methyl-4-vinyl-1,3-dioxolane-2-one

4-ethyl-4-vinyl-1,3-dioxolane-2-one

4-n-propyl-4-vinyl-1,3-dioxolane-2-one

5-methyl-4-vinyl-1,3-dioxolane-2-one

4,4-divinyl-1,3-dioxolane-2-one

4,5-divinyl-1,3-dioxolane-2-one

Specially, vinylethylene carbonate is preferable, since vinylethylene carbonate is easily available, and provides high effect. It is needless to say that all of R23 to R26 may be the vinyl group or the aryl group. Otherwise, it is possible that some of R23 to R26 are the vinyl group, and the others thereof are the aryl group.

The cyclic ester carbonate having an unsaturated bond shown in Chemical formula 7 is a methylene ethylene carbonate compound. Examples of the methylene ethylene carbonate compound include 4-methylene-1,3-dioxolane-2-one, 4,4-dimethyl-5-methylene-1,3-dioxolane-2-one, and 4,4-diethyl-5-methylene-1,3-dioxolane-2-one. The methylene ethylene carbonate compound may have one methylene group (compound shown in Chemical formula 7), or have two methylene groups.

The cyclic ester carbonate having an unsaturated bond may be catechol carbonate having a benzene ring or the like, in addition to the compounds shown in Chemical formula 5 to Chemical formula 7.

Further, the solvent preferably contains sultone (cyclic sulfonic ester) and an acid anhydride, since thereby chemical stability of the electrolytic solution is further improved.

Examples of sultone include propane sultone and propene sultone. Specially, propene sultone is preferable. Such sultone may be used singly, or a plurality thereof may be used by mixture. The sultone content in the solvent is, for example, in the range from 0.5 wt % to 5 wt %.

Examples of acid anhydride include carboxylic anhydride such as succinic anhydride, glutaric anhydride, and maleic anhydride; disulfonic anhydride such as ethane disulfonic anhydride and propane disulfonic anhydride; and an anhydride of carboxylic acid and sulfonic acid such as sulfobenzoic anhydride, sulfopropionic anhydride, and sulfobutyric anhydride. Specially, succinic anhydride or sulfobenzoic anhydride is preferable. The anhydrides may be used singly, or a plurality thereof may be used by mixture. The content of the acid anhydride in the solvent is, for example, from 0.5 wt % to 5 wt % both inclusive.

The electrolyte salt contains, for example, one or more light metal salts such as a lithium salt. The electrolyte salts described below may be combined arbitrarily.

As the lithium salt, for example, the following lithium salts are preferable, since thereby a superior battery electric characteristics are obtained in an electrochemical device.

lithium hexafluorophosphate

lithium tetrafluoroborate

lithium perchlorate

lithium hexafluoroarsenate

lithium tetraphenylborate (LiB(C₆H₅)₄)

lithium methanesulfonate (LiCH₃SO₃)

lithium trifluoromethane sulfonate (LiCF₃SO₃)

lithium tetrachloroaluminate (LiAlCl₄)

dilithium hexafluorosilicate (Li₂SiF₆)

lithium chloride (LiCl)

lithium bromide (LiBr)

As a lithium salt, of the foregoing, at least one selected from the group consisting of lithium hexafluorophosphate, lithium tetrafluoroborate, lithium perchlorate, and lithium hexafluoroarsenate is preferable, and lithium hexafluorophosphate is more preferable, since the internal resistance is lowered and higher effect is obtained.

In particular, the electrolyte salt preferably contains at least one selected from the group consisting of the compounds shown in Chemical formula 8 to Chemical formula 10. Thereby, in the case where such a compound is used together with the foregoing lithium hexafluorophosphate or the like, higher effect is obtained. R31 and R33 in Chemical formula 8 may be identical or different. The same is applied to R41 to R43 in Chemical formula 9 and R51 and R52 in Chemical formula 10.

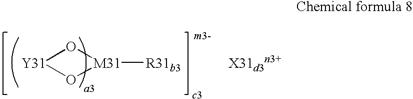

In the formula, X31 is a Group 1 element or a Group 2 element in the long period periodic table or aluminum. M31 is a transition metal element, a Group 13 element, a Group 14 element, or a Group 15 element in the long period periodic table. R31 is a halogen group. Y31 is —(O═)C—R32-C(═O)—, —(O═)C—C(R33)₂-, or —(O═)C—C(═O)—. R32 is an alkylene group, an alkylene halide group, an arylene group, or an arylene halide group. R33 is an alkyl group, an alkyl halide group, an aryl group, or an aryl halide group. a3 is one of integer numbers 1 to 4. b3 is 0, 2, or 4. c3, d3, m3, and n3 are one of integer numbers 1 to 3.

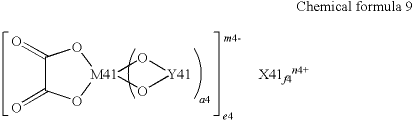

In the formula, X41 is a Group 1 element or a Group 2 element in the long period periodic table. M41 is a transition metal element, a Group 13 element, a Group 14 element, or a Group 15 element in the long period periodic table. Y41 is —(O═)C—(C(R41)₂)_{b4}-C(═O)—, —(R43)₂C—(C(R42)₂)_{c4}-C(═O)—, —(R43)₂C—(C(R42)₂)_{c4}-C(R43)₂-, —(R43)₂C—(C(R42)₂)_{c4}-S(═O)₂—, —(O═)₂S—(C(R42)₂)_{d4}-S(═O)₂—, or —(O═)C—(C(R42)₂)_{d4}-S(═O)₂—. R41 and R43 are a hydrogen group, an alkyl group, a halogen group, or an alkyl halide group. At least one of R41/R43 is respectively the halogen group or the alkyl halide group. R42 is a hydrogen group, an alkyl group, a halogen group, or an alkyl halide group. a4, e4, and n4 are an integer number of 1 or 2. b4 and d4 are one of integer numbers 1 to 4. c4 is one of integer numbers 0 to 4. f4 and m4 are one of integer numbers 1 to 3.

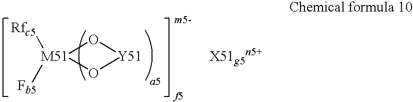

In the formula, X51 is a Group 1 element or a Group 2 element in the long period periodic table. M51 is a transition metal element, a Group 13 element, a Group 14 element, or a Group 15 element in the long period periodic table. Rf is a fluorinated alkyl group with the carbon number in the range from 1 to 10 or a fluorinated aryl group with the carbon number in the range from 1 to 10. Y51 is —(O═)C—(C(R51)₂)_{d5}-C(═O)—, —(R52)₂C—(C(R51)₂)_{d5}-C(═O)—, —(R52)₂C—(C(R51)₂)_{d5}-C(R52)₂-, —(R52)₂C—(C(R51)₂)_{d5}-S(═O)₂—, —(O═)₂S—(C(R51)₂)ₑ₅-S(═O)₂—, or —(O═)C—(C(R51)₂)ₑ₅-S(═O)₂—. R51 is a hydrogen group, an alkyl group, a halogen group, or an alkyl halide group. R52 is a hydrogen group, an alkyl group, a halogen group, or an alkyl halide group, and at least one thereof is the halogen group or the alkyl halide group. a5, f5, and n5 are 1 or 2. b5, c5, and e5 are one of integer numbers 1 to 4. d5 is one of integer numbers 0 to 4. g5 and m5 are one of integer numbers 1 to 3.

The long period periodic table is shown in “Inorganic chemistry nomenclature (revised edition)” proposed by IUPAC (International Union of Pure and Applied Chemistry). Specifically, Group 1 element represents hydrogen, lithium, sodium, potassium, rubidium, cesium, and francium. Group 2 element represents beryllium, magnesium, calcium, strontium, barium, and radium. Group 13 element represents boron, aluminum, gallium, indium, and thallium. Group 14 element represents carbon, silicon, germanium, tin, and lead. Group 15 element represents nitrogen, phosphorus, arsenic, antimony, and bismuth.

Examples of the compound shown in Chemical formula 8 include the compounds shown in Chemical formulas 11(1) to 11(6). Examples of the compound shown in Chemical formula 9 include the compounds shown in Chemical formulas 12(1) to 12(8). Examples of the compound shown in Chemical formula 10 include the compound shown in Chemical formula 13. It is needless to say that the compound is not limited to the compounds shown in Chemical formula 11(1) to Chemical formula 13, and the compound may be other compound as long as such a compound has the structure shown in Chemical formula 8 to Chemical formula 10.

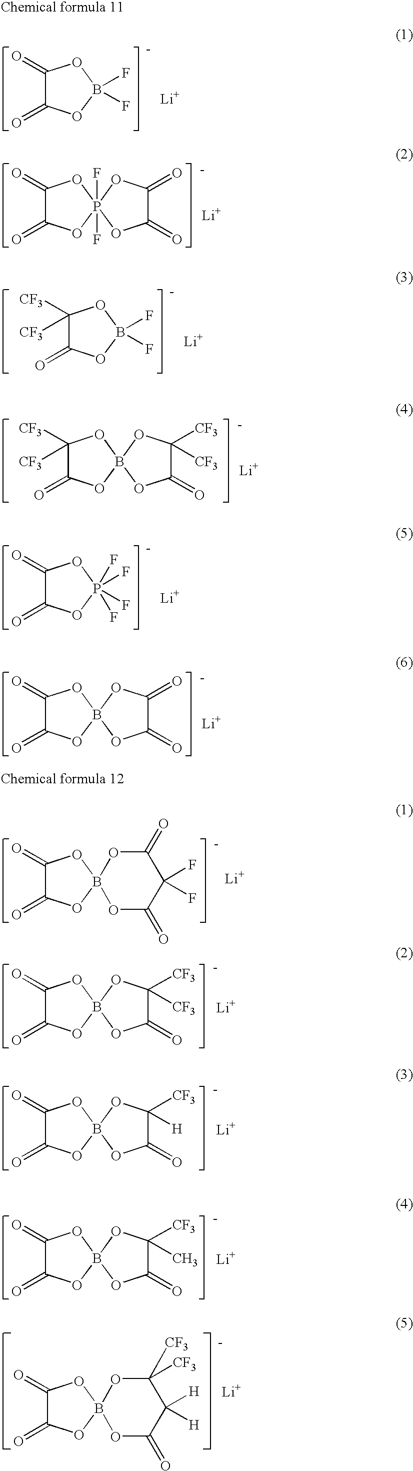

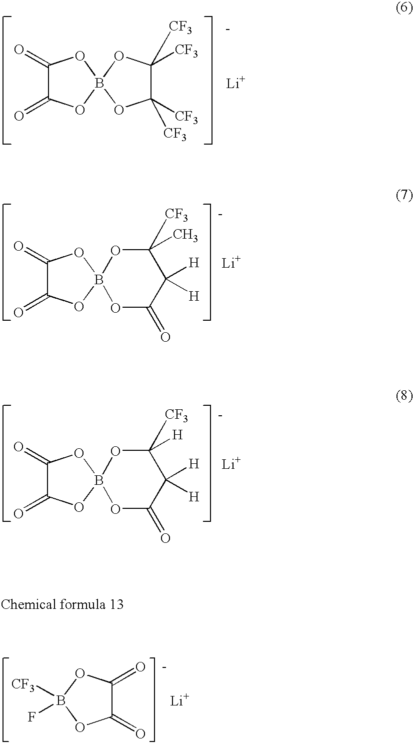

Further, the electrolyte salt may contain at least one selected from the group consisting of the compounds shown in Chemical formula 14 to Chemical formula 16. Thereby, in the case where such a compound is used together with the foregoing lithium hexafluorophosphate or the like, higher effect is obtained. m and n in Chemical formula 14 may be identical or different. The same is applied to p, q, and r in Chemical formula 16.

LiN(CₘF₂ₘ₊₁SO₂)(CₙF₂ₙ₊₁SO₂) Chemical formula 14

In the formula, m and n are an integer number of 1 or more.

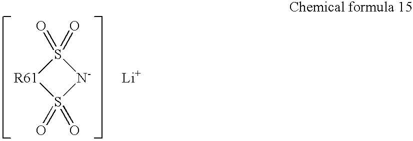

In the formula, R61 is a straight chain/branched perfluoro alkylene group with the carbon number in the range from 2 to 4.

LiC(CₚF₂ₚ₋₁SO₂)(C_{q}F_{2q+1}SO₂)(CᵣF₂ᵣ₊₁SO₂) Chemical formula 16

In the formula, p, q, and r are an integer number of 1 or more.

Examples of the chain compound shown in Chemical formula 14 include the following compounds:

lithium bis(trifluoromethanesulfonyl)imide (LiN(CF₃SO₂)₂)

lithium bis(pentafluoroethanesulfonyl)imide (LiN(C₂F₅SO₂)₂)

lithium(trifluoromethanesulfonyl)(pentafluoroethanesulfonyl)imide (LiN(CF₃SO₂)(C₂F₅SO₂))

lithium(trifluoromethanesulfonyl)(heptafluoropropanesulfonyl)imide (LiN(CF₃SO₂)(C₃F₇SO₂))

lithium(trifluoromethanesulfonyl)(nonafluorobutanesulfonyl)imide (LiN(CF₃SO₂)(C₄F₉SO₂))

One thereof may be used singly, or a plurality thereof may be used by mixture.

Examples of the cyclic compound shown in Chemical formula 15 include the compounds shown in Chemical formulas 17(1) to 17(4).

Chemical formula 17(1): 1,2-perfluoroethanedisulfonyl imide lithium

Chemical formula 17(2): 1,3-perfluoropropanedisulfonyl imide lithium

Chemical formula 17(3): 1,3-perfluorobutanedisulfonyl imide lithium

Chemical formula 17(4): 1,4-perfluorobutanedisulfonyl imide lithium

One thereof may be used singly, or a plurality thereof may be used by mixture. Specially, 1,2-perfluoroethanedisulfonyl imide lithium of Chemical formula 17(1) is preferable, since thereby high effect is obtained.

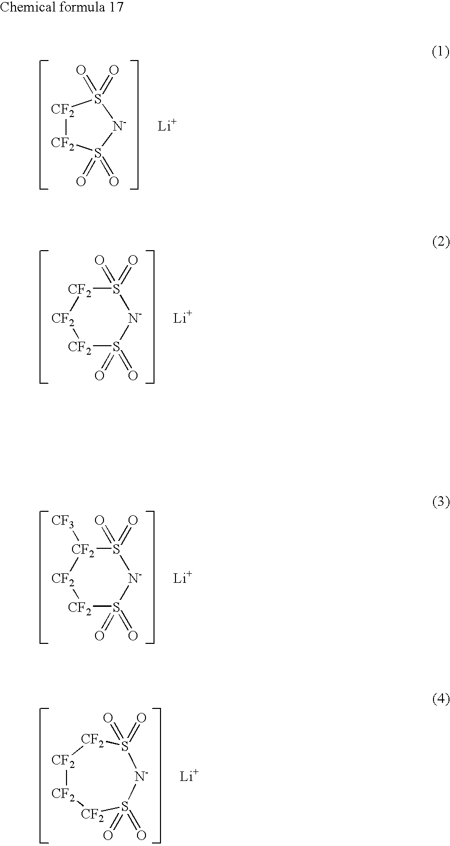

Examples of the chain compound shown in Chemical formula 16 include lithium tris(trifluoromethanesulfonyl)methyde (LiC(CF₃SO₂)₃).

The content of the electrolyte salt to the solvent is preferably from 0.3 mol/kg to 3.0 mol/kg both inclusive. If out of the foregoing range, there is a possibility that the ion conductivity is significantly lowered.

The secondary battery is manufactured, for example, by the following procedure.

First, the cathode 21 is formed. First, a cathode active material, a cathode binder, and a cathode electrical conductor are mixed to prepare a cathode mixture, which is dispersed in an organic solvent to form paste cathode mixture slurry. Subsequently, both faces of the cathode current collector 21A are uniformly coated with the cathode mixture slurry by using a doctor blade, a bar coater or the like, which is dried. Finally, the coating is compression-molded by using a rolling press machine or the like while being heated if necessary to form the cathode active material layer 21B. In this case, the resultant may be compression-molded over several times.

Next, the anode 22 is formed by forming the anode active material layer 22B on both faces of the anode current collector 22A by the same procedure as that of forming the anode described above.

Next, the battery element 20 is formed by using the cathode 21 and the anode 22. First, the cathode lead 24 is attached to the cathode current collector 21A by welding or the like, and the anode lead 25 is attached to the anode current collector 22A by welding or the like. Subsequently, the cathode 21 and the anode 22 are layered with the separator 23 in between, and then are spirally wound in the longitudinal direction. Finally, the spirally wound body is formed into a planular shape.

The secondary battery is assembled as follows. First, after the battery element 20 is contained in the battery can 11, the insulating plate 12 is arranged on the battery element 20. Subsequently, the cathode lead 24 is connected to the cathode pin 15 by welding or the like, and the anode lead 25 is connected to the battery can 11 by welding or the like. After that, the battery cover 13 is fixed on the open end of the battery can 11 by laser welding or the like. Finally, the electrolytic solution is injected into the battery can 11 from the injection hole 19, and impregnated in the separator 23. After that, the injection hole 19 is sealed by the sealing member 19A. The secondary battery illustrated in FIG. 4 and FIG. 5 is thereby completed.

In the secondary battery, when charged, for example, lithium ions are extracted from the cathode 21, and are inserted in the anode 22 through the electrolytic solution impregnated in the separator 23. Meanwhile, when discharged, for example, lithium ions are extracted from the anode 22, and are inserted in the cathode 21 through the electrolytic solution impregnated in the separator 23.

According to the square secondary battery, since the anode 22 has the structure similar to one of the structures of foregoing anodes 10, 10A, and 10B, the cycle characteristics are able to be improved.

In particular, in the case where the solvent of the electrolytic solution contains the chain ester carbonate having halogen shown in Chemical formula 1, the cyclic ester carbonate having halogen shown in Chemical formula 2, the cyclic ester carbonate having an unsaturated bond shown in Chemical formula 5 to Chemical formula 7, sultone, or an acid anhydride, higher effect is able to be obtained.

Further, in the case where the electrolyte salt of the electrolytic solution contains lithium hexafluorophosphate, lithium tetrafluoroborate, lithium perchlorate, lithium hexafluoroarsenate, the compounds shown in Chemical formula 8 to Chemical formula 10, the compounds shown in Chemical formula 14 to Chemical formula 16 or the like, higher effect is able to be obtained.

Further, in the case where the battery can 11 is made of a rigid metal, compared to a case that the battery can 11 is made of a soft film, the anode 22 is hardly broken in the case where the anode active material layer 22B is expanded or shrunk. Accordingly, the cycle characteristics are able to be further improved. In this case, in the case where the battery can 11 is made of iron that is more rigid than aluminum, higher effect is able to be obtained.

Effects of the secondary battery other than the foregoing effects are similar to those of the foregoing anodes 10, 10A, and 10B.

Second Secondary Battery

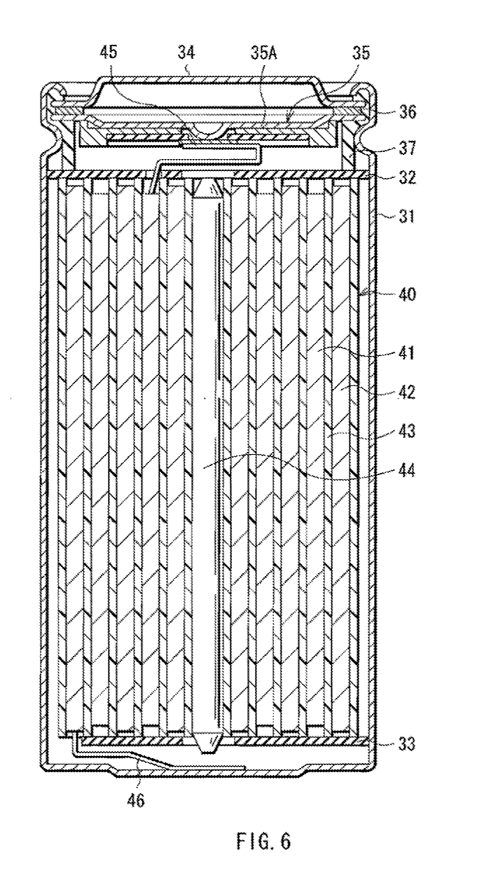

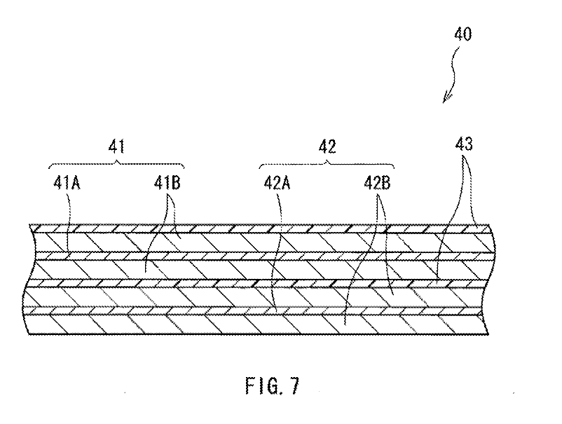

FIG. 6 and FIG. 7 illustrate a cross sectional structure of a second secondary battery as this embodiment. FIG. 7 illustrates an enlarged part of a spirally wound electrode body 40 illustrated in FIG. 6. The second secondary battery is, for example, a lithium ion secondary battery as the foregoing first secondary battery. The second secondary battery mainly contains the spirally wound electrode body 40 in which a cathode 41 and an anode 42 are layered with a separator 43 in between and spirally wound, and a pair of insulating plates 32 and 33 inside a battery can 31 in the shape of an approximately hollow cylinder. The battery structure including the battery can 31 is a so-called cylindrical type.

The battery can 31 is made of, for example, a metal material similar to that of the battery can 11 in the foregoing first secondary battery. One end of the battery can 31 is closed, and the other end of the battery can 31 is opened. The pair of insulating plates 32 and 33 is arranged to sandwich the spirally wound electrode body 40 in between and to extend perpendicularly to the spirally wound periphery face.

At the open end of the battery can 31, a battery cover 34, and a safety valve mechanism 35 and a PTC (Positive Temperature Coefficient) device 36 provided inside the battery cover 34 are attached by being caulked with a gasket 37. Inside of the battery can 31 is thereby hermetically sealed. The battery cover 34 is made of, for example, a metal material similar to that of the battery can 31. The safety valve mechanism 35 is electrically connected to the battery cover 34 through the PTC device 36. In the safety valve mechanism 35, in the case where the internal pressure becomes a certain level or more by internal short circuit, external heating or the like, a disk plate 35A inverts to cut the electric connection between the battery cover 34 and the spirally wound electrode body 40. As temperature rises, the PTC device 36 increases the resistance and thereby limits a current to prevent abnormal heat generation resulting from a large current. The gasket 37 is made of, for example, an insulating material. The surface of the gasket 37 is coated with asphalt.

A center pin 44 may be inserted in the center of the spirally wound electrode body 40. In the spirally wound electrode body 40, a cathode lead 45 made of a metal material such as aluminum is connected to the cathode 41, and an anode lead 46 made of a metal material such as nickel is connected to the anode 42. The cathode lead 45 is electrically connected to the battery cover 34 by being welded to the safety valve mechanism 35. The anode lead 46 is welded and thereby electrically connected to the battery can 31.

The cathode 41 has a structure in which, for example, a cathode active material layer 41B is provided on both faces of a cathode current collector 41A having a pair of faces. The anode 42 has a structure similar to one of the structures of the foregoing anodes 10, 10A, and 10B. For example, the anode 42 has a structure in which an anode active material layer 42B or the like is provided on both faces of an anode current collector 42A. The structures of the cathode current collector 41A, the cathode active material layer 41B, the anode current collector 42A, the anode active material layer 42B, and the separator 43 and the composition of the electrolytic solution are respectively similar to the structures of the cathode current collector 21A, the cathode active material layer 21B, the anode current collector 22A, the anode active material layer 22B, and the separator 23, and the composition of the electrolytic solution in the foregoing first secondary battery.

The secondary battery is manufactured, for example, by the following procedure.

First, for example, the cathode 41 is formed by forming the cathode active material layer 41B on both faces of the cathode current collector 41A and the anode 42 is formed by forming the anode active material layer 42B on both faces of the anode current collector 42A with the use of procedures similar to the procedures of forming the cathode 21 and the anode 22 in the foregoing first secondary battery. Subsequently, the cathode lead 45 is attached to the cathode 41 by welding or the like, and the anode lead 46 is attached to the anode 42 by welding or the like. Subsequently, the cathode 41 and the anode 42 are layered with the separator 43 in between and spirally wound, and thereby the spirally wound electrode body 40 is formed. After that, the center pin 44 is inserted in the center of the spirally wound electrode body. Subsequently, the spirally wound electrode body 40 is sandwiched between the pair of insulating plates 32 and 33, and contained in the battery can 31. The end of the cathode lead 45 is welded to the safety valve mechanism 35, and the end of the anode lead 46 is welded to the battery can 31. Subsequently, the electrolytic solution is injected into the battery can 31 and impregnated in the separator 43. Finally, at the open end of the battery can 31, the battery cover 34, the safety valve mechanism 35, and the PTC device 36 are fixed by being caulked with the gasket 37. The secondary battery illustrated in FIG. 6 and FIG. 7 is thereby completed.

In the secondary battery, when charged, for example, lithium ions are extracted from the cathode 41 and inserted in the anode 42 through the electrolytic solution. Meanwhile, when discharged, for example, lithium ions are extracted from the anode 42, and inserted in the cathode 41 through the electrolytic solution.

According to the cylindrical type secondary battery, the anode 42 has the structure similar to that of the foregoing anode. Thus, the cycle characteristics and the initial charge and discharge characteristics are able to be improved. Effects of the secondary battery other than the foregoing effects are similar to those of the first secondary battery.

Third Secondary Battery

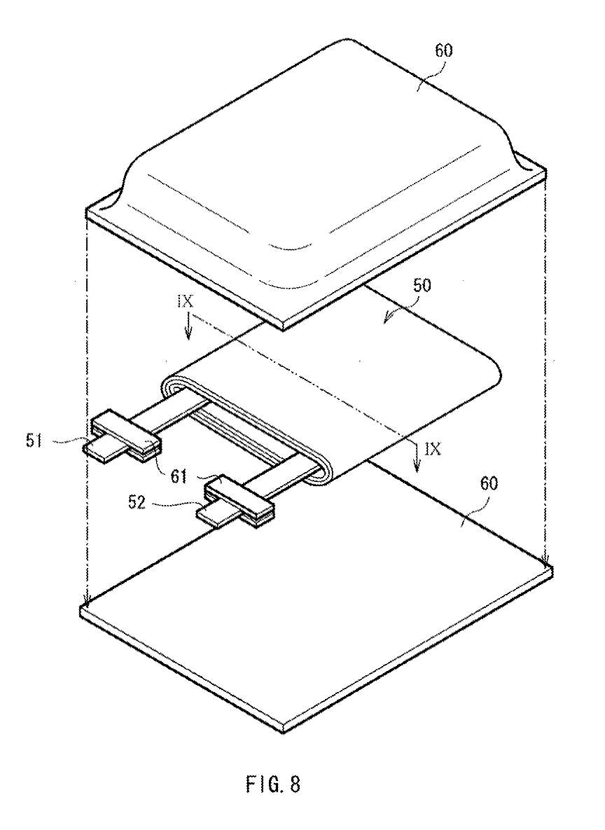

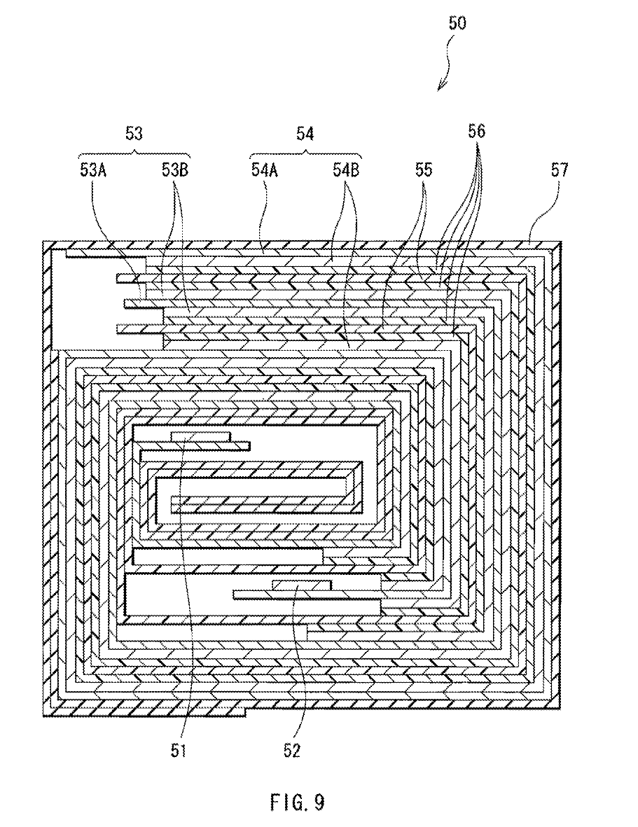

FIG. 8 illustrates an exploded perspective structure of a third secondary battery. FIG. 9 illustrates an exploded cross section taken along line IX-IX illustrated in FIG. 8. The third secondary battery is, for example, a lithium ion secondary battery as the foregoing first secondary battery. In the third secondary battery, a spirally wound electrode body 50 on which a cathode lead 51 and an anode lead 52 are attached is contained in a film package member 60. The battery structure including the package member 60 is so-called laminated film type.

The cathode lead 51 and the anode lead 52 are respectively directed from inside to outside of the package member 60 in the same direction, for example. The cathode lead 51 is made of, for example, a metal material such as aluminum, and the anode lead 52 is made of, for example, a metal material such as copper, nickel, and stainless. These metal materials are in the shape of a thin plate or mesh.

The package member 60 is made of an aluminum laminated film in which, for example, a nylon film, an aluminum foil, and a polyethylene film are bonded together in this order. The package member 60 has, for example, a structure in which the respective outer edges of 2 pieces of rectangle aluminum laminated films are bonded with each other by fusion bonding or an adhesive so that the polyethylene film and the spirally wound electrode body 50 are opposed to each other.

An adhesive film 61 to protect from entering of outside air is inserted between the package member 60 and the cathode lead 51, the anode lead 52. The adhesive film 61 is made of a material having contact characteristics to the cathode lead 51 and the anode lead 52. Examples of such a material include, for example, a polyolefin resin such as polyethylene, polypropylene, modified polyethylene, and modified polypropylene.

The package member 60 may be made of a laminated film having other laminated structure, a polymer film such as polypropylene, or a metal film, instead of the foregoing aluminum laminated film.

In the spirally wound electrode body 50, a cathode 53 and an anode 54 are layered with a separator 55 and an electrolyte 56 in between and spirally wound. The outermost periphery thereof is protected by a protective tape 57.

The cathode 53 has a structure in which, for example, a cathode active material layer 53B is provided on both faces of a cathode current collector 53A having a pair of faces. The anode 54 has a structure similar to one of the structures of the foregoing anodes 10, 10A, and 10B. For example, the anode 54 has a structure in which an anode active material layer 54B is provided on both faces of an anode current collector 54A having a pair of faces. The structures of the cathode current collector 53A, the cathode active material layer 53B, the anode current collector 54A, the anode active material layer 54B, and the separator 55 are respectively similar to those of the cathode current collector 21A, the cathode active material layer 21B, the anode current collector 22A, the anode active material layer 22B, and the separator 23 of the foregoing first secondary battery.

The electrolyte 56 is a so-called gel electrolyte, containing an electrolytic solution and a polymer compound that holds the electrolytic solution. The gel electrolyte is preferable, since high ion conductivity (for example, 1 mS/cm or more at room temperature) is obtained and liquid leakage is prevented.

Examples of polymer compounds include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethylmethacrylate, polyacrylic acid, polymethacrylic acid, styrene-butadiene rubber, nitrile-butadiene rubber, polystyrene, and polycarbonate. One of these polymer compounds may be used singly, or two or more thereof may be used by mixture. Specially, polyacrylonitrile, polyvinylidene fluoride, polyhexafluoropropylene, polyethylene oxide or the like is preferably used, since such a compound is electrochemically stable.

The composition of the electrolytic solution is similar to the composition of the electrolytic solution in the first secondary battery. However, in the electrolyte 56 as the gel electrolyte, the solvent in the electrolytic solution means a wide concept including not only the liquid solvent but also a solvent having ion conductivity capable of dissociating the electrolyte salt. Therefore, in the case where the polymer compound having ion conductivity is used, the polymer compound is also included in the solvent.

Instead of the gel electrolyte 56 in which the electrolytic solution is held by the polymer compound, the electrolytic solution may be directly used. In this case, the electrolytic solution is impregnated in the separator 55.

The secondary battery including the gel electrolyte 56 is manufactured, for example, by the following three procedures.

In the first manufacturing method, first, for example, the cathode 53 is formed by forming the cathode active material layer 53B on both faces of the cathode current collector 53A, and the anode 54 is formed by forming the anode active material layer 54B on both faces of the anode current collector 54A by a procedure similar to the procedure of forming the cathode 21 and the anode 22 in the foregoing first secondary battery. Subsequently, a precursor solution containing an electrolytic solution, a polymer compound, and a solvent is prepared. After the cathode 53 and the anode 54 are coated with the precursor solution, the solvent is volatilized to form the gel electrolyte 56. Subsequently, the cathode lead 51 is attached to the cathode current collector 53A, and the anode lead 52 is attached to the anode current collector 54A. Subsequently, the cathode 53 and the anode 54 provided with the electrolyte 56 are layered with the separator 55 in between and spirally wound to obtain a laminated body. After that, the protective tape 57 is adhered to the outermost periphery thereof to form the spirally wound electrode body 50. Finally, for example, after the spirally wound electrode body 50 is sandwiched between 2 pieces of the film package members 60, outer edges of the package members 60 are bonded by thermal fusion bonding or the like to enclose the spirally wound electrode body 50. At this time, the adhesive films 61 are inserted between the cathode lead 51, the anode lead 52 and the package member 60. Thereby, the secondary battery illustrated in FIG. 8 and FIG. 9 is completed.

In the second manufacturing method, first, the cathode lead 51 is attached to the cathode 53, and the anode lead 52 is attached to the anode 54. Subsequently, the cathode 53 and the anode 54 are layered with the separator 55 in between and spirally wound. After that, the protective tape 57 is adhered to the outermost periphery thereof, and thereby a spirally wound body as a precursor of the spirally wound electrode body 50 is formed. Subsequently, after the spirally wound body is sandwiched between 2 pieces of the film package members 60, the outermost peripheries except for one side are bonded by thermal fusion bonding or the like to obtain a pouched state, and the spirally wound body is contained in the pouch-like package member 60. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 60. After that, the opening of the package member 60 is hermetically sealed by thermal fusion bonding or the like. Finally, the monomer is thermally polymerized to obtain a polymer compound. Thereby, the gel electrolyte 56 is formed. Accordingly, the secondary battery illustrated in FIG. 8 and FIG. 9 is completed.

In the third manufacturing method, the spirally wound body is formed and contained in the pouch-like package member 60 in the same manner as that of the foregoing second manufacturing method, except that the separator 55 with both faces coated with a polymer compound is used firstly. Examples of polymer compounds with which the separator 55 is coated include a polymer containing vinylidene fluoride as a component, that is, a homopolymer, a copolymer, a multicomponent copolymer or the like. Specific examples include polyvinylidene fluoride, a binary copolymer containing vinylidene fluoride and hexafluoropropylene as a component, and a ternary copolymer containing vinylidene fluoride, hexafluoropropylene, and chlorotrifluoroethylene as a component. As a polymer compound, in addition to the foregoing polymer containing vinylidene fluoride as a component, another one or more polymer compounds may be contained. Subsequently, an electrolytic solution is prepared and injected into the package member 60. After that, the opening of the package member 60 is sealed by thermal fusion bonding or the like. Finally, the resultant is heated while a weight is applied to the package member 60, and the separator 55 is contacted with the cathode 53 and the anode 54 with the polymer compound in between. Thereby, the electrolytic solution is impregnated into the polymer compound, and the polymer compound is gelated to form the electrolyte 56. Accordingly, the secondary battery as illustrated in FIG. 8 and FIG. 9 is completed.

In the third manufacturing method, the swollenness of the secondary battery is inhibited compared to the first manufacturing method. Further, in the third manufacturing method, the monomer, the solvent and the like as a raw material of the polymer compound are hardly left in the electrolyte 56 compared to the second manufacturing method. In addition, the formation step of the polymer compound is favorably controlled. Thus, sufficient contact characteristics are obtained between the cathode 53/the anode 54/the separator 55 and the electrolyte 56.

According to the laminated film secondary battery, the anode 54 has the structure similar to one of the structures of the foregoing anodes 10, 10A, and 10B. Thus, the cycle characteristics and the initial charge and discharge characteristics are able to be improved. Effect of the secondary battery other than the foregoing effect is similar to that of the first secondary battery.

### EXAMPLES

### Example 1-1

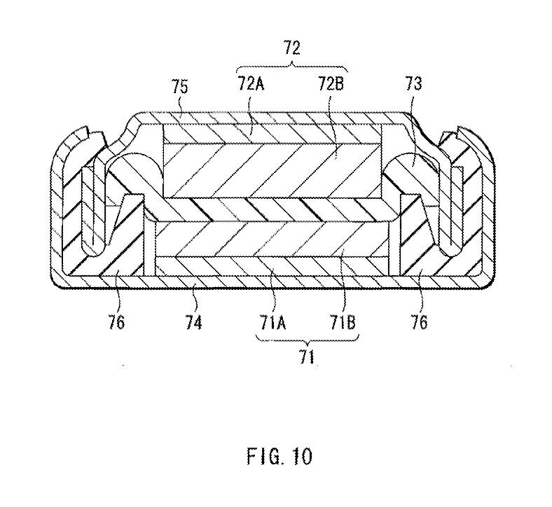

The coin type secondary battery illustrated in FIG. 10 was fabricated by the following procedure. The secondary battery was obtained by layering a cathode 71 and an anode 72 with a separator 73 in between, sandwiching the laminated body between a package can 74 and a package cup 75, and sealing the resultant through a gasket 76. In the cathode 71, a cathode active material layer 71B was provided on a cathode current collector 71A. In the anode 72, an anode active material layer 72B was provided on an anode current collector 72A.

First, the cathode 71 was formed. Specifically, lithium carbonate (Li₂CO₃) and cobalt carbonate (CoCO₃) were mixed at a molar ratio of 0.5:1. After that, the mixture was fired in the air at 900 deg C. for 5 hours. Thereby, lithium cobalt complex oxide (LiCoO₂) was obtained. Subsequently, 96 parts by mass of the lithium cobalt complex oxide as a cathode active material, 1 part by mass of graphite as an electrical conductor, and 3 parts by mass of polyvinylidene fluoride as a binder were mixed to obtain a cathode mixture. After that, the cathode mixture was dispersed in N-methyl-2-pyrrolidone to obtain paste cathode mixture slurry. A single face of the cathode current collector 71A made of an aluminum foil having a thickness of 15 μm was uniformly coated with the cathode mixture slurry, which was dried. After that, the resultant was compression-molded by a roll pressing machine to form the cathode active material layer 71B. Finally, the resultant was punched out into a pellet having a diameter of 15.5 mm to form the cathode 71.

Next, the anode 72 was formed as follows. First, the anode current collector 72A made of an electrolytic copper foil (thickness: 24 μm, ten point height of roughness profile Rz: 3.0 μm) was prepared. After that, the anode active material layer 72B was formed on a single face of the anode current collector 72A by electron beam evaporation method using a deflecting electron beam evaporation source while introducing oxygen gas continuously and moisture vapor according to needs into a chamber. Specifically, silicon as an anode active material was deposited 1400 times, and thereby a plurality of anode active material particles having a multilayer structure were formed. The thickness of the anode active material particles (total film thickness) was 8.4 μm. Thus, the film thickness per one layer on an average was 5.0 nm. In this case, the following operation was repeated. That is, after one layer was deposited, a closure plate (shutter) was sandwiched between the evaporation source and the evaporation recipient (anode current collector 72A) in a state that the evaporation source was heated. After the anode current collector 72A was sufficiently cooled, the closure plate was removed, and evaporation was restarted to deposit the next layer. At this time, due to existence of a small amount of oxygen existing in the chamber, every time when one layer of the anode active material was formed, the surface thereof was oxidized, and an oxide layer of SiOx (0<x<2) was slightly formed. That is, a layer having a higher oxygen content was formed between the layers of the anode active material. The fact that the thickness of each layer was about 5 nm was confirmed by forming a cross section by chronosection polisher method (CP method) and observing the cross section by a transmission electron microscope (TEM). Further, silicon with 99% purity was used as the evaporation method, the deposition rate was 150 nm/sec, and the content ratio of oxygen in the anode active material particles was 5 atomic %. Further, evaporation was performed in a state that the anode current collector 72A was fixed relatively to the evaporation source.

Subsequently, the foregoing cathode 71 and the foregoing anode 72 were layered so that the separator 73 was sandwiched between the cathode 71 and the anode 72, and the resultant was laid inside the package can 74, onto which an electrolytic solution was injected. After that, the resultant was caulked by covering with the package cup 75. As the separator 73, a three layer structured polymer separator (total thickness: 23 μm) in which a film having porous polyethylene as a main component was sandwiched between two films having porous polypropylene as a main component was used. As the electrolytic solution, a solution in which LiPF₆ as an electrolyte salt was dissolved in the solvent obtained by mixing 30 wt % of ethylene carbonate, 60 wt % of diethyl carbonate, and 10 wt % of vinylene carbonate (VC) was used. The package can 74 and the package cup 75 were made of iron. Accordingly, the coin type secondary battery was completed.

### Examples 1-2 to 1-16

A coin type secondary battery was fabricated in the same manner as that of Example 1-1, except that the number of layers of the anode active material layer 72B was changed in the range from 6 to 840 as illustrated in Table 1 (the thickness of each layer in the multilayer structure was changed in the range from 10 nm to 1400 nm).

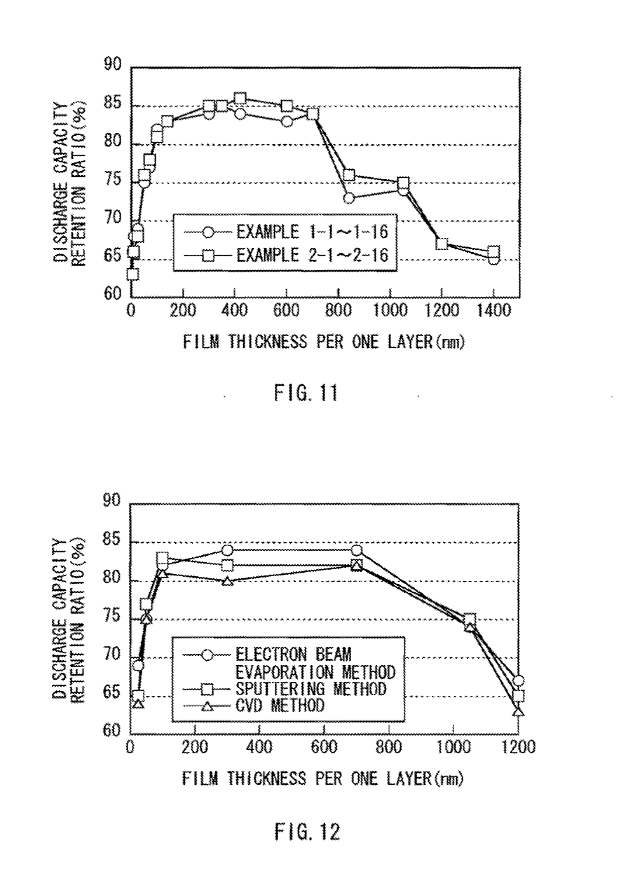

The cycle characteristics for the secondary batteries of Examples 1-1 to 1-16 were examined in the following manner. The results illustrated in Table 1 and FIG. 11 were obtained. FIG. 11 is a characteristics diagram illustrating a relation between a film thickness (nm) per one layer of the multilayer structure composing the anode active material layer 72B and a discharge capacity retention ratio (%) calculated described below.

In examining the cycle characteristics, a cycle test was performed in the following procedure, and thereby the discharge capacity retention ratio was obtained. First, to stabilize the battery state, 1 cycle of charge and discharge was performed in the atmosphere at 23 deg C. Subsequently, 99 cycle of charge and discharge were performed in the same atmosphere. Thereby, the discharge capacity at the 100th cycle was measured. Finally, the discharge capacity retention ratio (%)=(discharge capacity at the 100th cycle/discharge capacity at the second cycle)*100 was calculated. For the charge at the first cycle, after constant current charge was performed at the constant current density of 0.2 mA/cm² until the battery voltage reached 4.2 V, constant voltage charge was continuously performed at the constant voltage of 4.2 V until the current value reached 0.01 mA/cm². For the discharge at the first cycle, discharge was performed at the constant current density of 0.2 mA/cm² until the battery voltage reached 2.7 V. For the charge at cycles on and after the second cycle, after charge was performed at the constant current density of 2 mA/cm² until the battery voltage reached 4.2 V, charge was continuously performed at the constant voltage of 4.2 V until the current density reached 0.1 mA/cm². For the discharge at cycles on and after the second cycle, discharge was performed at the constant current density of 0.2 mA/cm² until the battery voltage reached 2.5 V.

The procedures and the conditions in examining the foregoing cycle characteristics are similarly applied to evaluating the same characteristics for the following examples.

TABLE 1
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | |
|---|---|---|---|---|
| | (total film thickness: 8.4 μm) | | | Discharge |
| | | | Film | capacity |
| | State of anode | Number of | thickness | retention |
| | current collector | layers | per one layer | ratio |
| | in forming | (layer) | (nm) | (%) |
| Example 1-1 | Fixed | 1680 | 5 | 66 |
| Example 1-2 | Fixed | 840 | 10 | 68 |
| Example 1-3 | Fixed | 336 | 25 | 69 |
| Example 1-4 | Fixed | 168 | 50 | 75 |
| Example 1-5 | Fixed | 120 | 70 | 77 |
| Example 1-6 | Fixed | 84 | 100 | 82 |
| Example 1-7 | Fixed | 60 | 140 | 83 |
| Example 1-8 | Fixed | 28 | 300 | 84 |
| Example 1-9 | Fixed | 24 | 350 | 85 |
| Example 1-10 | Fixed | 20 | 420 | 84 |
| Example 1-11 | Fixed | 14 | 600 | 83 |
| Example 1-12 | Fixed | 12 | 700 | 84 |
| Example 1-13 | Fixed | 10 | 840 | 73 |
| Example 1-14 | Fixed | 8 | 1050 | 74 |
| Example 1-15 | Fixed | 7 | 1200 | 67 |
| Example 1-16 | Fixed | 6 | 1400 | 65 |

As illustrated in Table 1 and FIG. 11, in the case where the thickness of each layer in the multilayer structure composing the anode active material particles was from 50 nm to 1050 nm both inclusive, a discharge capacity retention ratio higher than that in which the thickness of each layer in the multilayer structure composing the anode active material particles was out of the foregoing range. In particular, in the case where the thickness of each layer was from 100 nm to 700 nm both inclusive, a higher discharge capacity retention ratio was obtained.

### Examples 2-1 to 2-16

A coin type secondary battery was fabricated in the same manner as that of Example 1-1, except that evaporation was performed while the anode current collector 72A was rotated with respect to the evaporation source in forming the anode active material layer 72B.

The cycle characteristics for the secondary batteries of Examples 2-1 to 2-16 were examined. The results illustrated in Table 2 and FIG. 11 were obtained.

TABLE 2
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | |
|---|---|---|---|---|
| | (total film thickness: 8.4 μm) | | | |
| | State of | | Film | Discharge |
| | anode | | thickness | capacity |
| | current | Number of | per one | retention |
| | collector in | layers | layer | ratio |
| | forming | (layer) | (nm) | (%) |
| Example 2-1 | Rotated | 1680 | 5 | 63 |
| Example 2-2 | Rotated | 840 | 10 | 66 |
| Example 2-3 | Rotated | 336 | 25 | 68 |
| Example 2-4 | Rotated | 168 | 50 | 76 |
| Example 2-5 | Rotated | 120 | 70 | 78 |
| Example 2-6 | Rotated | 84 | 100 | 81 |
| Example 2-7 | Rotated | 60 | 140 | 83 |
| Example 2-8 | Rotated | 28 | 300 | 85 |
| Example 2-9 | Rotated | 24 | 350 | 85 |
| Example 2-10 | Rotated | 20 | 420 | 86 |
| Example 2-11 | Rotated | 14 | 600 | 85 |
| Example 2-12 | Rotated | 12 | 700 | 84 |
| Example 2-13 | Rotated | 10 | 840 | 76 |
| Example 2-14 | Rotated | 8 | 1050 | 75 |
| Example 2-15 | Rotated | 7 | 1200 | 67 |
| Example 2-16 | Rotated | 6 | 1400 | 66 |

As illustrated in Table 2 and FIG. 11, results almost equal to those of Examples 1-1 to 1-16 were obtained.

### Examples 3-1 to 3-7

A coin type secondary battery was fabricated in the same manner as that of Examples 1-3, 1-4, 1-6, 1-8, 1-12, 1-14, and 1-15, except that the anode active material particles were formed by using sputtering method instead of electron beam evaporation method.

### Examples 3-8 to 3-14

A coin type secondary battery was fabricated in the same manner as that of Examples 1-3, 1-4, 1-6, 1-8, 1-12, 1-14, and 1-15, except that the anode active material particles were formed by using CVD method instead of electron beam evaporation method. At this time, as a raw material and excited gas, silane (SiH₄) and argon (Ar) were respectively used, and the substrate temperature was 200 deg C.

The cycle characteristics for the secondary batteries of Examples 3-1 to 3-14 were examined. The results illustrated in Table 3 and FIG. 12 were obtained. FIG. 12 is a characteristics diagram illustrating a relation between a film thickness (nm) per one layer of the multilayer structure composing the anode active material layer 72B and a discharge capacity retention ratio (%), expressing comparison based on difference of methods of forming the anode active material layer.

TABLE 3
Anode active material: Si
Content ratio of oxygen in anode active material: 5 atomic %
Ten point height of roughness profile Rz of surface of anode current
collector: 3.0 μm

| | Anode active material layer | | | |
|---|---|---|---|---|
| | (total film thickness: 8.4 μm) | | | |
| | | | Film | |
| | | | thickness | Discharge |
| | | Number of | per one | capacity |
| | Formation | layers | layer | retention ratio |
| | method | (layer) | (nm) | (%) |
| Example 3-1 | Sputtering | 336 | 25 | 65 |
| | method | | | |
| Example 3-2 | Sputtering | 168 | 50 | 77 |
| | method | | | |
| Example 3-3 | Sputtering | 84 | 100 | 83 |
| | method | | | |
| Example 3-4 | Sputtering | 28 | 300 | 82 |
| | method | | | |
| Example 3-5 | Sputtering | 12 | 700 | 82 |
| | method | | | |
| Example 3-6 | Sputtering | 8 | 1050 | 75 |
| | method | | | |
| Example 3-7 | Sputtering | 7 | 1200 | 65 |
| | method | | | |
| Example 3-8 | CVD method | 336 | 25 | 64 |
| Example 3-9 | CVD method | 168 | 50 | 75 |
| Example 3-10 | CVD method | 84 | 100 | 81 |
| Example 3-11 | CVD method | 28 | 300 | 80 |
| Example 3-12 | CVD method | 12 | 700 | 82 |
| Example 3-13 | CVD method | 8 | 1050 | 74 |
| Example 3-14 | CVD method | 7 | 1200 | 63 |

As illustrated in Table 3 and FIG. 12, there was a tendency that a slightly higher discharge capacity retention ratio was obtained in the case of forming the anode active material particles by electron beam evaporation method than in the case of forming the anode active material particles by using sputtering method or CVD method.

### Examples 4-1 to 4-6

A coin type secondary battery was fabricated in the same manner as that of Examples 1-3, 1-4, 1-6, 1-8, 1-12, 1-14, and 1-15, except that a mixture containing silicon and iron was used instead of purity 99% silicon as an evaporation source, and the anode active material particles having silicon and iron as an anode active material were formed. The content ratio of iron in the anode active material was 5 atomic %.

### Examples 4-7 to 4-12

A coin type secondary battery was fabricated in the same manner as that of Examples 4-1 to 4-6, except that the content ratio of iron in the anode active material was 10 atomic %.

### Examples 4-13 to 4-18

A coin type secondary battery was fabricated in the same manner as that of Examples 4-1 to 4-6, except that a mixture containing silicon and cobalt was used as an evaporation source, and the anode active material particles having silicon and cobalt were formed. The content ratio of cobalt in the anode active material was 5 atomic %.

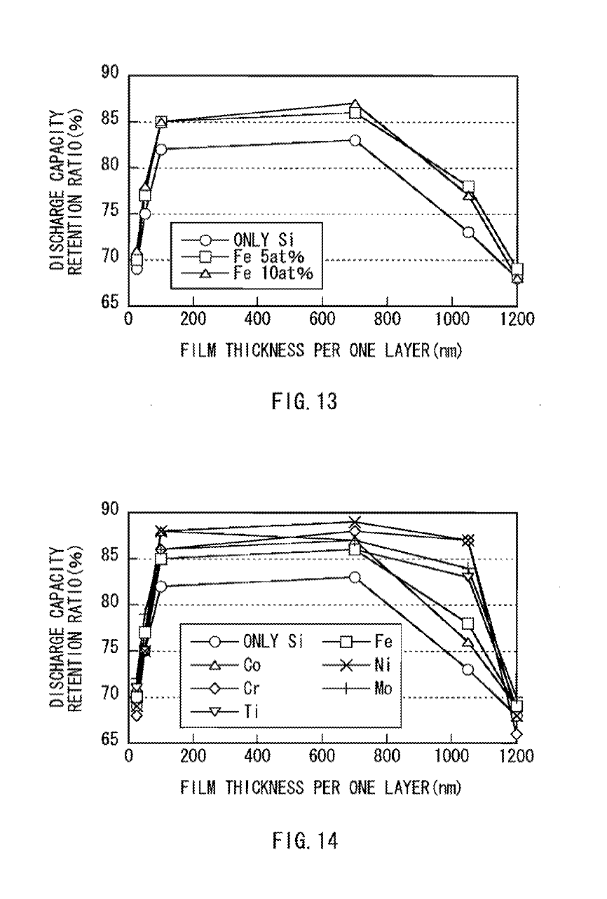

The cycle characteristics for the secondary batteries of Examples 4-1 to 4-18 were examined. The results illustrated in Table 4, FIG. 13, and FIG. 14 were obtained. FIG. 13 and FIG. 14 are a characteristics diagram illustrating a relation between a film thickness (nm) per one layer of the multilayer structure composing the anode active material layer 72B and a discharge capacity retention ratio (%). In particular, FIG. 13 is a result from comparison based on difference of content ratio of iron as an anode active material. Further, FIG. 14 is a result from comparison based on difference of metal elements contained together with silicon as an anode active material.

TABLE 4
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | | |
|---|---|---|---|---|---|
| | (total film thickness: 8.4 μm) | | | | |
| | Metal element | | | | |
| | in anode | | | Film | Discharge |
| | active material | | | thickness | capacity |
| | | Content | Number | per one | retention |
| | | ratio | of layers | layer | ratio |
| | Type | (atomic %) | (layer) | (nm) | (%) |
| Example 4-1 | Fe | 5 | 336 | 25 | 70 |
| Example 4-2 | Fe | 5 | 168 | 50 | 77 |
| Example 4-3 | Fe | 5 | 84 | 100 | 85 |
| Example 4-4 | Fe | 5 | 12 | 700 | 86 |
| Example 4-5 | Fe | 5 | 8 | 1050 | 78 |
| Example 4-6 | Fe | 5 | 7 | 1200 | 69 |
| Example 4-7 | Fe | 10 | 336 | 25 | 71 |
| Example 4-8 | Fe | 10 | 168 | 50 | 78 |
| Example 4-9 | Fe | 10 | 84 | 100 | 85 |
| Example 4-10 | Fe | 10 | 12 | 700 | 87 |
| Example 4-11 | Fe | 10 | 8 | 1050 | 77 |
| Example 4-12 | Fe | 10 | 7 | 1200 | 68 |
| Example 4-13 | Co | 5 | 336 | 25 | 71 |
| Example 4-14 | Co | 5 | 168 | 50 | 77 |
| Example 4-15 | Co | 5 | 84 | 100 | 88 |
| Example 4-16 | Co | 5 | 12 | 700 | 87 |
| Example 4-17 | Co | 5 | 8 | 1050 | 76 |
| Example 4-18 | Co | 5 | 7 | 1200 | 69 |

### Examples 5-1 to 5-6

A coin type secondary battery was fabricated in the same manner as that of Examples 4-1 to 4-6, except that a mixture containing silicon and nickel was used as an evaporation source, and the anode active material particles having silicon and nickel were formed. The content ratio of nickel in the anode active material was 5 atomic %.

### Examples 5-7 to 5-12

A coin type secondary battery was fabricated in the same manner as that of Examples 4-1 to 4-6, except that a mixture containing silicon and chromium was used as an evaporation source, and the anode active material particles having silicon and chromium were formed. The content ratio of chromium in the anode active material was 5 atomic %.

### Examples 5-13 to 5-18

A coin type secondary battery was fabricated in the same manner as that of Examples 4-1 to 4-6, except that a mixture containing silicon and molybdenum was used as an evaporation source, and the anode active material particles having silicon and molybdenum were formed. The content ratio of molybdenum in the anode active material was 5 atomic %.

### Examples 5-19 to 5-24

A coin type secondary battery was fabricated in the same manner as that of Examples 4-1 to 4-6, except that a mixture containing silicon and titanium was used as an evaporation source, and the anode active material particles having silicon and titanium were formed. The content ratio of titanium in the anode active material was 5 atomic %.

The cycle characteristics for the secondary batteries of Examples 5-1 to 5-24 were examined. The results illustrated in Table 5 and FIG. 14 were obtained.

TABLE 5
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | | |
|---|---|---|---|---|---|
| | (total film thickness: 8.4 μm) | | | | |
| | Metal | | | | |
| | element in anode | | | Film | |
| | active material | | | thickness | Discharge |
| | | Content | Number | per | capacity |
| | | ratio | of | one | retention |
| | | (atomic | layers | layer | ratio |
| | Type | %) | (layer) | (nm) | (%) |
| Example 5-1 | Ni | 5 | 336 | 25 | 69 |
| Example 5-2 | Ni | 5 | 168 | 50 | 75 |
| Example 5-3 | Ni | 5 | 84 | 100 | 88 |
| Example 5-4 | Ni | 5 | 12 | 700 | 89 |
| Example 5-5 | Ni | 5 | 8 | 1050 | 87 |
| Example 5-6 | Ni | 5 | 7 | 1200 | 68 |
| Example 5-7 | Cr | 5 | 336 | 25 | 68 |
| Example 5-8 | Cr | 5 | 168 | 50 | 75 |
| Example 5-9 | Cr | 5 | 84 | 100 | 86 |
| Example 5-10 | Cr | 5 | 12 | 700 | 88 |
| Example 5-11 | Cr | 5 | 8 | 1050 | 87 |
| Example 5-12 | Cr | 5 | 7 | 1200 | 66 |
| Example 5-13 | Mo | 5 | 336 | 25 | 72 |
| Example 5-14 | Mo | 5 | 168 | 50 | 79 |
| Example 5-15 | Mo | 5 | 84 | 100 | 86 |
| Example 5-16 | Mo | 5 | 12 | 700 | 87 |
| Example 5-17 | Mo | 5 | 8 | 1050 | 84 |
| Example 5-18 | Mo | 5 | 7 | 1200 | 70 |
| Example 5-19 | Ti | 5 | 336 | 25 | 71 |
| Example 5-20 | Ti | 5 | 168 | 50 | 75 |
| Example 5-21 | Ti | 5 | 84 | 100 | 85 |
| Example 5-22 | Ti | 5 | 12 | 700 | 86 |
| Example 5-23 | Ti | 5 | 8 | 1050 | 83 |
| Example 5-24 | Ti | 5 | 7 | 1200 | 69 |

As illustrated in Table 4, Table 5, FIG. 13, and FIG. 14, it was found that a higher discharge capacity retention ratio was obtained by adding the foregoing metal element to the anode active material in addition to silicon.

### Examples 6-1 to 6-5

A coin type secondary battery was fabricated in the same manner as that of Example 1-8, except that the content ratio of oxygen in the anode active material particles was 1.5 atomic % (Example 6-1), 3 atomic % (Example 6-2), 20 atomic % (Example 6-3), 40 atomic % (Example 6-4), or 50 atomic % (Example 6-5) instead of 5 atomic %.

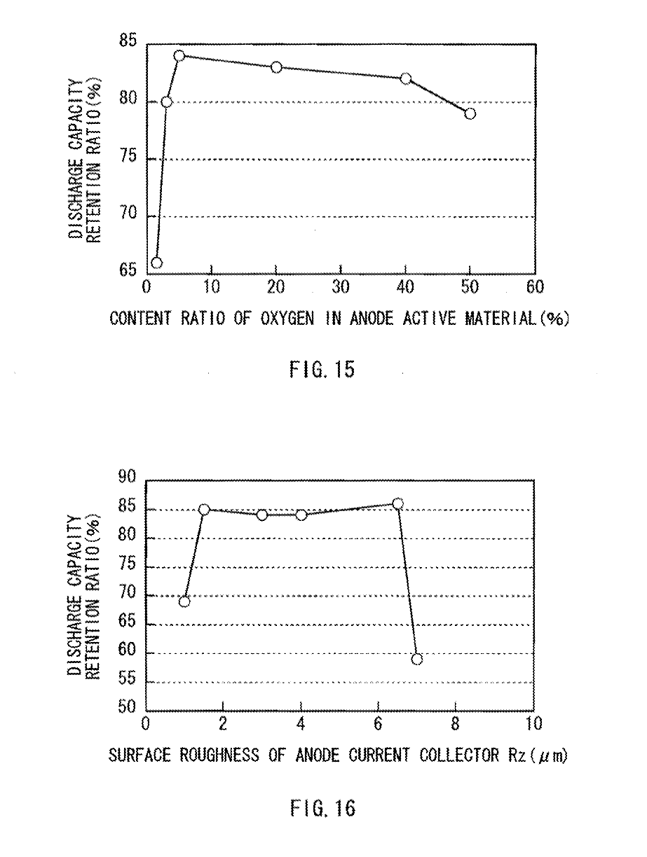

The cycle characteristics for the secondary batteries of Examples 6-1 to 6-5 were examined. The results illustrated in Table 6 and FIG. 15 were obtained. Table 6 also illustrates the result of Example 1-8. Further, FIG. 15 is a characteristics diagram illustrating a relation between a content ratio of oxygen (%) in the anode active material particles and a discharge capacity retention ratio (%).

TABLE 6
Anode active material: Si (electron beam evaporation method)
Ten point height of roughness profile Rz of surface of anode current
collector: 3.0 μm

| | Anode active material layer | | | |
|---|---|---|---|---|
| | (total film thickness: 8.4 μm) | | | |
| | Content | | Film | Discharge |
| | ratio of | | thickness | capacity |
| | oxygen | Number of | per one | retention |
| | (atomic | layers | layer | ratio |
| | %) | (layer) | (nm) | (%) |
| Example 6-1 | 1.5 | 28 | 300 | 66 |
| Example 6-2 | 3.0 | 28 | 300 | 80 |
| Example 1-8 | 5.0 | 28 | 300 | 84 |
| Example 6-3 | 20.0 | 28 | 300 | 83 |
| Example 6-4 | 40.0 | 28 | 300 | 82 |
| Example 6-5 | 50.0 | 28 | 300 | 79 |

As illustrated in Table 6 and FIG. 15, it was found that in the case where the content ratio of oxygen in the anode active material particles was from 3 atomic % to 40 atomic % both inclusive, a higher discharge capacity retention ratio was able to be obtained.

### Examples 7-1 to 7-6

A coin type secondary battery was fabricated in the same manner as that of Example 1-8, except that the surface roughness (Rz value) of the anode current collector 72A was changed in the range from 1.0 μm to 7.0 μm as illustrated in Table 7.

The cycle characteristics for the secondary batteries of Examples 7-1 to 7-6 were examined. The results illustrated in Table 7 and FIG. 16 were obtained. Table 7 also illustrates the result of Example 1-8. Further, FIG. 16 is a characteristics diagram illustrating a relation between a surface roughness of the anode current collector 72A (Rz value: μm) of the anode current collector 72A and a discharge capacity retention ratio (%).

TABLE 7
Anode active material: Si (electron beam evaporation method)
Total film thickness of anode active material layer: 8.4 μm
Content ratio of oxygen in anode active material: 5 atomic %

| | | Anode active | | |
|---|---|---|---|---|
| | | material layer | | |
| | Anode current | | Film | |
| | collector | | thickness | Discharge |
| | Surface | Number | per one | capacity |
| | roughness Rz | of layers | layer | retention ratio |
| | (μm) | (layer) | (nm) | (%) |
| Example 7-1 | 1.0 | 28 | 300 | 69 |
| Example 7-2 | 1.5 | 28 | 300 | 85 |
| Example 1-8 | 3.0 | 28 | 300 | 84 |
| Example 7-4 | 4.0 | 28 | 300 | 84 |
| Example 7-5 | 6.5 | 28 | 300 | 86 |
| Example 7-6 | 7.0 | 28 | 300 | 59 |

As illustrated in Table 7 and FIG. 16, it was found that in the case where the surface roughness (Rz value) of the anode current collector 72A was from 1.5 μm to 6.5 μm both inclusive, a higher discharge capacity retention ratio was able to be obtained.

### Examples 8-1 to 8-7

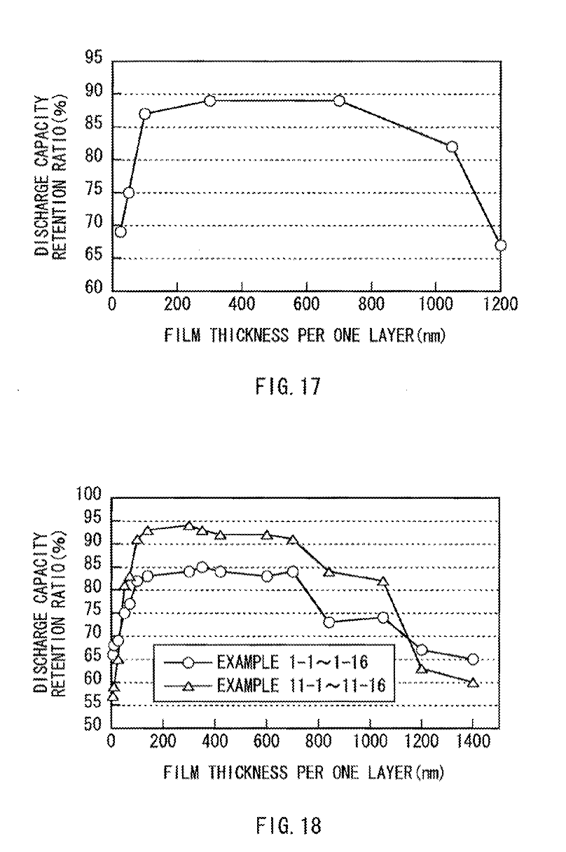

A coin type secondary battery was fabricated in the same manner as that of Examples 1-3, 1-4, 1-6, 1-8, 1-12, 1-14, and 1-16, except that the content ratio of oxygen in the anode active material particles was 10 atomic % instead of 5 atomic %, and the surface roughness (Rz value) of the anode current collector 72A was changed to 3.0 μm as illustrated in Table 8. The cycle characteristics for the secondary batteries of Examples 8-1 to 8-7 were examined. The results illustrated in Table 8 and FIG. 17 were obtained. FIG. 17 is a characteristics diagram illustrating a relation between a film thickness (nm) per one layer of the multilayer structure composing the anode active material layer 72B and a discharge capacity retention ratio (%).

TABLE 8
Anode active material: Si (electron beam evaporation method)
Total film thickness of anode active material layer: 8.4 μm
Content ratio of oxygen in anode active material: 10 atomic %

| | | Anode active | | |
|---|---|---|---|---|
| | Anode current | material layer | | |
| | collector | | Film | Discharge |
| | Surface | Number of | thickness per | capacity |
| | roughness Rz | layers | one layer | retention ratio |
| | (μm) | (layer) | (nm) | (%) |
| Example 8-1 | 3.0 | 336 | 25 | 69 |
| Example 8-2 | 3.0 | 168 | 50 | 75 |
| Example 8-3 | 3.0 | 84 | 100 | 87 |
| Example 8-4 | 3.0 | 28 | 300 | 89 |
| Example 8-5 | 3.0 | 12 | 700 | 89 |
| Example 8-6 | 3.0 | 8 | 1050 | 82 |
| Example 8-7 | 3.0 | 7 | 1200 | 67 |

As illustrated in Table 8 and FIG. 17, even if the content ratio of oxygen in the anode active material particles was 10 atomic %, in the case where the thickness of each layer in the multilayer structure composing the anode active material particles was from 50 nm to 1050 nm both inclusive, a discharge capacity retention ratio higher than that in which the thickness of each layer in the multilayer structure composing the anode active material particles was out of the foregoing range. In particular, in the case where the thickness of each layer was from 100 nm to 700 nm both inclusive, a higher discharge capacity retention ratio was obtained.

### Example 9-1

A coin type secondary battery was fabricated in the same manner as that of Example 1-8, except that 4-fluoro-1,3-dioxolane-2-one (FEC) was added instead of EC and VC as a solvent, and the solvent composition (FEC:DEC) was changed to 50:50 at a weight ratio.

### Example 9-2

A coin type secondary battery was fabricated in the same manner as that of Example 1-8, except that 4,5-difluoro-1,3-dioxolane-2-one (DFEC) was added instead of VC as a solvent, and the solvent composition (EC:DEC:DFEC) was changed to 25:70:5 at a weight ratio.

### Example 9-3

A coin type secondary battery was fabricated in the same manner as that of Example 1-8, except that FEC was added instead of EC as a solvent, and the solvent composition (DEC:FEC:VC) was changed to 49.5:49.5:1.0 at a weight ratio.

### Example 9-4

A coin type secondary battery was fabricated in the same manner as that of Example 1-8, except that FEC and vinylethylene carbonate (VEC) were added instead of EC and VC as a solvent, and the solvent composition (DEC:FEC:VEC) was changed to 49.5:49.5:1.0 at a weight ratio.

### Example 9-5

A coin type secondary battery was fabricated in the same manner as that of Example 9-1, except that as a solvent, 1,3-propene sultone (PRS) as sultone was added. At this time, the concentration of PRS in the electrolytic solution was 1 wt %. “1 wt %” means that where a whole solvent excluding PRS was 100 wt %, a portion corresponding to 1 wt % of PRS was added.

### Example 9-6

A coin type secondary battery was fabricated in the same manner as that of Example 9-1, except that lithium tetrafluoroborate (LiBF₄) was further added as an electrolyte salt, and the content of LiPF₆ was changed to 0.9 mol/kg, and the content of LiBF₄ was changed to 0.1 mol/kg.

### Examples 9-7 and 9-8

A coin type secondary battery was fabricated in the same manner as that of Example 9-1, except that sulfobenzoic acid anhydride (SBAH: Example 9-7) or sulfopropionate anhydride (SPAH: Example 9-8) as an acid anhydride was added to an electrolytic solution as an additive. At this time, the contents of SBAH and SPAH in the electrolytic solution were 1 wt %. “1 wt %” means that where a whole solvent was 100 wt %, a portion corresponding to 1 wt % of SBAH or SPAH was added.

The cycle characteristics for the secondary batteries of Examples 9-1 to 9-8 were examined. The results illustrated in Table 9 were obtained.

TABLE 9
Anode active material: Si (electron beam evaporation method)
Total film thickness of anode active material layer: 8.4 μm
Content ratio of oxygen in anode active material: 5 atomic %
Ten point height of roughness profile Rz of surface of anode current
collector: 3.0 μm
Number of anode active material layers: 28

| | | | | | | | | | Discharge |
|---|---|---|---|---|---|---|---|---|---|
| | Electrolytic solution | | | | | | | | capacity |
| | | | | | | | Electrolyte | | retention |
| | Solvent (wt %) | | | | | | salt | Others | ratio |
| | EC | DEC | FEC | DFEC | VC | VEC | mol/kg | wt % | (%) |
| Example 1-8 | 30 | 60 | — | — | 10 | — | LiPF₆: 1 | — | 84 |
| Example 9-1 | — | 50 | 50 | — | — | — | LiPF₆: 1 | — | 85 |
| Example 9-2 | 25 | 70 | — | 5 | — | — | LiPF₆: 1 | — | 88 |
| Example 9-3 | — | 49.5 | 49.5 | — | 1.0 | — | LiPF₆: 1 | — | 88 |
| Example 9-4 | — | 49.5 | 49.5 | — | — | 1.0 | LiPF₆: 1 | — | 88 |
| Example 9-5 | — | 50 | 50 | — | — | — | LiPF₆: 1 | PRS: 1 | 87 |
| Example 9-6 | — | 50 | 50 | — | — | — | LiPF₆: 1.0 | — | 89 |
| | | | | | | | LiBF₄: 0.1 | | |
| Example 9-7 | — | 50 | 50 | — | — | — | LiPF₆: 1 | SBAH: 1 | 93 |
| Example 9-8 | — | 50 | 50 | — | — | — | LiPF₆: 1 | SPAH: 1 | 94 |

PRS: 1,3-propene sultone
SBAH: sulfobenzoic acid anhydride
SPAH: sulfopropionate anhydride

As illustrated in Table 9, it was found that in the case where FEC or DFEC was added as a solvent, the discharge capacity retention ratio was further improved. Further, in the case where SBAH or SPAH was added into the electrolytic solution as an additive (Examples 9-7 and 9-8), or LiBF₄ was added as an electrolyte salt (Example 9-6), a slightly higher discharge capacity retention ratio was able to be obtained compared to a case that SBAH, SPAH, or LiBF₄ was not added (Example 9-1).

### Example 10-1

A procedure similar to that of Example 1-8 was made, except that the laminated film type secondary battery illustrated in FIG. 8 and FIG. 9 was manufactured instead of the coin type secondary battery by the following procedure. At this time, the laminated film type secondary battery was manufactured as a lithium ion secondary battery in which the capacity of the anode 54 was expressed based on insertion and extraction of lithium.

First, the cathode 53 was formed. First, both faces of the cathode current collector 53A made of a strip-shaped aluminum foil (thickness: 12 μm) were uniformly coated with the cathode mixture slurry formed in the same manner as that of Example 1-1, which was dried. After that, the resultant was compression-molded by a roll pressing machine to form the cathode active material layer 53B.

Next, the anode 54 was formed. First, an electrolytic copper foil (thickness: 24 μm, ten point height of roughness profile Rz: 3 μm) was prepared as the anode current collector 54A, which was laid inside a chamber. After that, silicon was deposited on both faces of the anode current collector 54A by electron beam evaporation method while introducing oxygen gas into the chamber to form the anode active material particles having a thickness of 7 μm. Accordingly, the anode active material layer 54B was formed.

Finally, the secondary battery was assembled by using the cathode 53, the anode 54, and the electrolytic solution similar to that of Example 1-1. First, the cathode lead 51 made of aluminum was welded to one end of the cathode current collector 53A, and the anode lead 52 made of nickel was welded to one end of the anode current collector 54A. Subsequently, the cathode 53, the separator 55 (thickness: 23 μm) having a 3-layer structure in which a film made of a microporous polyethylene as a main component was sandwiched between two films made of a microporous polypropylene as a main component, the anode 54, and the foregoing separator 55 were layered in this order and spirally wound in the longitudinal direction. After that, the end portion of the spirally wound body was fixed by the protective tape 57 made of an adhesive tape, and thereby a spirally wound body as a precursor of the spirally wound electrode body 50 was formed. Subsequently, the spirally wound body was sandwiched between the package members 60 made of a 3-layer laminated film (total thickness: 100 μm) in which a nylon film (thickness: 30 μm), an aluminum foil (thickness: 40 μm), and a cast polypropylene film (thickness 30 μm) were layered from the outside. After that, outer edges other than an edge of one side of the package members were thermally fusion-bonded with each other. Thereby, the spirally wound body was contained in the package members 60 in a pouched state. Subsequently, the electrolytic solution was injected through the opening of the package member 60, the electrolytic solution was impregnated in the separator 55, and thereby the spirally wound electrode body 50 was formed. Finally, the opening of the package member 60 was sealed by thermal fusion bonding in the vacuum atmosphere, and thereby the laminated film secondary battery was completed. In manufacturing the secondary battery, the thickness of the cathode active material layer 53B was adjusted, and thereby lithium metal was prevented from being precipitated on the anode 54 at the time of full charge.

### Example 10-2

A coin type secondary battery was fabricated in the same manner as that of Example 1-8, except that the package can 74 and the package cup 75 made of aluminum were used instead of the package can 74 and the package cup 75 made of iron.

The cycle characteristics for the secondary batteries of Examples 10-1 and 10-2 were examined. The results illustrated in Table 10 were obtained. Table 10 also illustrates the result of Example 1-8.

TABLE 10
Anode active material: Si (electron beam evaporation method)
Total film thickness of anode active material layer: 8.4 μm
Content ratio of oxygen in anode active material: 5 atomic %
Ten point height of roughness profile Rz of surface of anode current
collector: 3.0 μm

| | | Anode active | | |
|---|---|---|---|---|
| | | material layer | | |
| | | | Film | Discharge |
| | | | thickness | capacity |
| | | Number of | per one | retention |
| | Battery | layers | layer | ratio |
| | structure | (layer) | (nm) | (%) |
| Example 10-1 | Laminated | 28 | 300 | 79 |
| | film type | | | |
| Example 10-2 | Coin type | 28 | 300 | 81 |
| | (aluminum) | | | |
| Example 1-8 | Coin type | 28 | 300 | 84 |
| | (iron) | | | |

As illustrated in Table 10, the discharge capacity retention ratio of the coin type secondary battery (Examples 10-2 and 1-8) was higher than that of the laminated film type secondary battery (Example 10-1). Further, the discharge capacity retention ratio of Example 1-8 in which the package member (the package can 74 and the package cup 75) was made of iron was higher than that of Example 10-2 in which the package member (the package can 74 and the package cup 75) was made of aluminum. Accordingly, it was confirmed that to further improve the cycle characteristics, the coin type battery structure was better than the laminated film type battery structure. In addition, it was confirmed that to furthermore improve the cycle characteristics, the package member made of iron was preferably used. Though not illustrated with a specific example, it is evident that similar results would be obtained in a cylindrical type or a square type secondary battery in which the package member is made of a metal material, since the cycle characteristics in the coin type secondary battery in which the package member was made of a metal material were further improved than those of the laminated film type secondary battery.

### Examples 11-1 to 11-16

A coin type secondary battery was fabricated in the same manner as that of Examples 1-1 to 1-16, except for the following points. Specifically, in forming the anode 72, after the anode active material particles were formed, a metal was formed by depositing cobalt on both faces of the anode current collector 72A by electrolytic plating method while supplying air to a plating bath. At this time, as a plating solution, a cobalt plating solution (Nippon Kojundo Kagaku Co., Ltd. make) was used. The current density was from 2 A/dm² to 5 A/dm² both inclusive, and the plating rate was 10 nm/sec. Further, the oxygen content in the metal was 5 atomic %, and the ratio (molar ratio) M2/M1 between the number of moles M1 per unit area of the anode active material particles and the number of moles M2 per unit area of the metal was 1/1. For the completed anode 72, after a cross section was exposed by FIB, local element analysis was performed by auger electron spectrometer (AES). In the result, it was confirmed that the element of the anode current collector 72A and the element of the anode active material layer 72B were diffused into each other at the interface between the anode current collector 72A and the anode active material layer 72B, that is, the both elements were alloyed.

### Examples 11-17 to 11-21

A coin type secondary battery was fabricated in the same manner as that of Example 11-8, except that a metal was formed by respectively depositing the metal elements illustrated in Table 11 instead of cobalt on both faces of the anode current collector 72A.

The cycle characteristics for the secondary batteries of Examples 11-1 to 11-21 were examined. The results illustrated in Table 11 and FIG. 18 (FIG. 18 illustrates only Examples 11-1 to 11-16) were obtained. Table 11 also illustrates the result of Example 1-8. FIG. 18 is a characteristics diagram illustrating a relation between a film thickness (nm) per one layer of the multilayer structure composing the anode active material layer 72B and a discharge capacity retention ratio (%), expressing comparison with Examples 1-1 to 1-16.

TABLE 11
Anode active material: Si (electron beam evaporation method)
Content ratio of oxygen in anode active material: 5 atomic %
Ten point height of roughness profile Rz of surface of anode current
collector: 3.0 μm

| | Anode active material | | | | |
|---|---|---|---|---|---|
| | layer (total film thickness: | | | | |
| | 8.4 μm) | | | | |
| | Metal (electrolytic | | | Film | Discharge |
| | plating method) | | | thickness | capacity |
| | | Molar | Number | per one | retention |
| | | ratio | of layers | layer | ratio |
| | Type | M2/M1 | (layer) | (nm) | (%) |
| Example 1-8 | — | — | 28 | 300 | 84 |
| Example 11-1 | Co | 1/1 | 1680 | 5 | 57 |
| Example 11-2 | Co | 1/1 | 840 | 10 | 59 |
| Example 11-3 | Co | 1/1 | 336 | 25 | 65 |
| Example 11-4 | Co | 1/1 | 168 | 50 | 81 |
| Example 11-5 | Co | 1/1 | 120 | 70 | 83 |
| Example 11-6 | Co | 1/1 | 84 | 100 | 91 |
| Example 11-7 | Co | 1/1 | 60 | 140 | 93 |
| Example 11-8 | Co | 1/1 | 28 | 300 | 94 |
| Example 11-9 | Co | 1/1 | 24 | 350 | 93 |
| Example 11-10 | Co | 1/1 | 20 | 420 | 92 |
| Example 11-11 | Co | 1/1 | 14 | 600 | 92 |
| Example 11-12 | Co | 1/1 | 12 | 700 | 91 |
| Example 11-13 | Co | 1/1 | 10 | 840 | 84 |
| Example 11-14 | Co | 1/1 | 8 | 1050 | 82 |
| Example 11-15 | Co | 1/1 | 7 | 1200 | 63 |
| Example 11-16 | Co | 1/1 | 6 | 1400 | 60 |
| Example 11-17 | Fe | 1/1 | 28 | 300 | 93 |
| Example 11-18 | Ni | 1/1 | 28 | 300 | 92 |
| Example 11-19 | Zn | 1/1 | 28 | 300 | 91 |
| Example 11-20 | Cu | 1/1 | 28 | 300 | 92 |
| Example 11-21 | Cr | 1/1 | 28 | 300 | 90 |

As illustrated in Table 11, since the metal was formed in Examples 11-8 and Examples 11-17 to 11-21, the discharge capacity retention ratio thereof was higher than that of Example 1-8 in which the metal was not formed. Further, from the results of Examples 11-1 to 11-16 (Table 11 and FIG. 18), it was found that in the case where the metal was formed, if the thickness of each layer composing the anode active material particles of the multilayer structure was from 50 nm to 1050 nm both inclusive, in particular, from 100 nm to 700 nm both inclusive, a higher discharge capacity retention ratio was able to be obtained.

### Examples 12-1 to 12-4

A coin type secondary battery was fabricated in the same manner as that of Example 11-8, except that in the anode active material layer 72B, the ratio (molar ratio) M2/M1 between the number of moles M1 per unit area of the anode active material particles and the number of moles M2 per unit area of the metal was changed as illustrated in Table 12.

The cycle characteristics for the secondary batteries of Examples 12-1 to 12-4 were examined. The results illustrated in Table 12 were obtained. Table 12 also illustrates the results of Examples 1-8 and 11-8.

TABLE 12
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | | |
|---|---|---|---|---|---|
| | (total film thickness: | | | | |
| | 8.4 μm) | | | | |
| | Metal (electrolytic | | | Film | Discharge |
| | plating method) | | | thickness | capacity |
| | | Molar | Number of | per one | retention |
| | | ratio | layers | layer | ratio |
| | Type | M2/M1 | (layer) | (nm) | (%) |
| Example 1-8 | — | — | 28 | 300 | 84 |
| Example 11-8 | Co | 1/1 | 28 | 300 | 94 |
| Example 12-1 | Co | 0.8/1 | 28 | 300 | 94 |
| Example 12-2 | Co | 0.5/1 | 28 | 300 | 92 |
| Example 12-3 | Co | 0.1/1 | 28 | 300 | 91 |
| Example 12-4 | Co | 0.01/1 | 28 | 300 | 90 |

[As illustrated in Table 12, it was found that in the case where the molar ratio (M2/M1) was from 0.01 to 1 both inclusive, the discharge capacity retention ratio was higher than that of Example 1-8 in which the metal was not formed. Further, it was found that as the foregoing value became closer to 1, a higher discharge capacity retention ratio was able to be obtained.

### Example 13-1

A coin type secondary battery was fabricated in the same manner as that of Example 11-8, except that the metal was formed by electroless plating method instead of electrolytic plating method. At this time, an electroless cobalt plating solution (Nippon Kojundo Kagaku Co., Ltd. make) was used as a plating solution, and plating time was 60 minutes.

### Example 13-2

A coin type secondary battery was fabricated in the same manner as that of Example 11-8, except that the metal was formed by electron beam evaporation method instead of electrolytic plating method. At this time, purity 99.9% cobalt was used as an evaporation source, and the deposition rate was 5 nm/sec.

### Example 13-3

A coin type secondary battery was fabricated in the same manner as that of Example 11-8, except that the metal was formed by sputtering method instead of electrolytic plating method. At this time, purity 99.9% cobalt was used as a target, and the deposition rate was 3 nm/sec.

### Example 13-4

A coin type secondary battery was fabricated in the same manner as that of Example 11-8, except that the metal was formed by using CVD method instead of electrolytic plating method. At this time, as a raw material and excited gas, silane (SiH₄) and argon (Ar) were respectively used, and the deposition rate and the substrate temperature were 1.5 nm/sec and 200 deg C.

The cycle characteristics for the secondary batteries of Examples 13-1 to 13-4 were examined. The results illustrated in Table 13 were obtained. Table 13 also illustrates the results of Examples 1-8 and 11-8.

TABLE 13
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | | | |
|---|---|---|---|---|---|---|
| | (total film thickness: 8.4 μm) | | | | | |
| | | | | | Film | Discharge |
| | Metal | | | | thickness | capacity |
| | | Molar | | Number | per one | retention |
| | | ratio | | of layers | layer | ratio |
| | Type | M2/M1 | Formation method | (layer) | (nm) | (%) |
| Example 1-8 | — | — | — | 28 | 300 | 84 |
| Example 11-8 | Co | 1/1 | Electrolytic | 28 | 300 | 94 |
| | | | plating method | | | |
| Example 13-1 | Co | 1/1 | Electroless | 28 | 300 | 83 |
| | | | plating method | | | |
| Example 13-2 | Co | 1/1 | Electron beam | 28 | 300 | 84 |
| | | | evaporation | | | |
| Example 13-3 | Co | 1/1 | Sputtering | 28 | 300 | 82 |
| | | | method | | | |
| Example 13-4 | Co | 1/1 | CVD method | 28 | 300 | 81 |

As illustrated in Table 13, the discharge capacity retention ratio in the case that the metal was formed by a method other than electrolytic plating method (Examples 13-1 to 13-4) was lower than that of the case that the metal was formed by electrolytic plating method (Example 11-8), and showed a value almost equal to that of the case that the metal was not formed (Example 1-8). That is, it was found that in the case where the metal was formed by electrolytic plating method, more favorable cycle characteristics were able to be obtained.

### Examples 14-1 to 14-16

A coin type secondary battery was fabricated in the same manner as that of Example 1-1 to 1-16, except that in forming the anode 72, after the anode active material particles were formed, a compound layer having Si—O bond and Si—N bond was provided on the surface of the anode active material particles as described below. Specifically, the anode active material particles provided on the anode current collector 72A were dipped into a solution in which perhydropolysilazane at a concentration of 5 wt % was dissolved in xylene for 3 minutes to provide polysilazane treatment. After the treated resultant was taken out, the resultant was left for 24 hours. In this stage, reaction between silicon composing the anode active material particles and perhydropolysilazane, decomposition reaction of the perhydropolysilazane itself and the like were generated. In the result, Si—N bond was formed, and Si—O bond was formed resulting from reaction between moisture in the air and partial perhydropolysilazane. After that, the resultant was washed with dimethyl carbonate (DMC), and was vacuum-dried. Thereby, the anode active material particles covered with the compound layer having Si—O bond and Si—N bond were obtained.

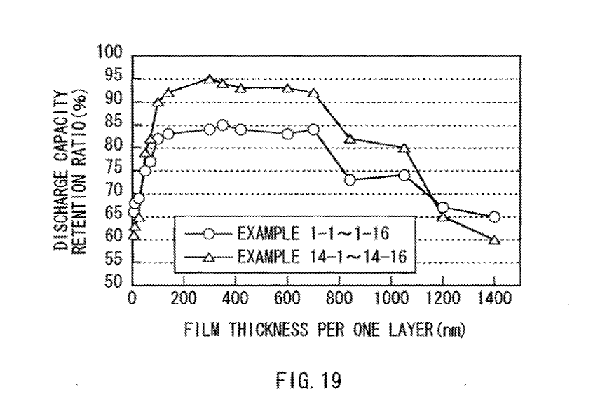

The cycle characteristics for the secondary batteries of Examples 14-1 to 14-16 were examined. The results illustrated in Table 14 and FIG. 19 were obtained. FIG. 19 is a characteristics diagram illustrating a relation between a film thickness (nm) per one layer of the multilayer structure composing the anode active material layer 72B and a discharge capacity retention ratio (%), expressing comparison with Examples 1-1 to 1-16.

TABLE 14
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | | |
|---|---|---|---|---|---|
| | (total film thickness: 8.4 μm) | | | | |
| | Surface treatment | | | Film | Discharge |
| | Formation | | | thickness | capacity |
| | of | Molar | Number | per one | retention |
| | compound | ratio | of layers | layer | ratio |
| | film | M2/M1 | (layer) | (nm) | (%) |
| Example 14-1 | Applicable | 1/1 | 1680 | 5 | 61 |
| Example 14-2 | Applicable | 1/1 | 840 | 10 | 63 |
| Example 14-3 | Applicable | 1/1 | 336 | 25 | 65 |
| Example 14-4 | Applicable | 1/1 | 168 | 50 | 79 |
| Example 14-5 | Applicable | 1/1 | 120 | 70 | 82 |
| Example 14-6 | Applicable | 1/1 | 84 | 100 | 90 |
| Example 14-7 | Applicable | 1/1 | 60 | 140 | 92 |
| Example 14-8 | Applicable | 1/1 | 28 | 300 | 95 |
| Example 14-9 | Applicable | 1/1 | 24 | 350 | 94 |
| Example 14-10 | Applicable | 1/1 | 20 | 420 | 93 |
| Example 14-11 | Applicable | 1/1 | 14 | 600 | 93 |
| Example 14-12 | Applicable | 1/1 | 12 | 700 | 92 |
| Example 14-13 | Applicable | 1/1 | 10 | 840 | 82 |
| Example 14-14 | Applicable | 1/1 | 8 | 1050 | 80 |
| Example 14-15 | Applicable | 1/1 | 7 | 1200 | 65 |
| Example 14-16 | Applicable | 1/1 | 6 | 1400 | 60 |

As illustrated in Table 14 and FIG. 19, in Examples 14-1 to 14-16, the anode active material particles were covered with the compound layer. Thus, compared to Examples 1-1 to 1-16 (Table 1) in which such a compound layer was not formed, the discharge capacity retention ratio thereof was higher if the film thickness was 1100 nm or less. Further, from the results of Examples 14-1 to 14-16, it was found that in the case where the compound layer was formed, if the thickness of each layer composing the anode active material particles of the multilayer structure was from 50 nm to 1050 nm both inclusive, in particular, from 100 nm to 700 nm both inclusive, a higher discharge capacity retention ratio was able to be obtained.

### Examples 15-1 to 15-4

A coin type secondary battery was fabricated in the same manner as that of Example 14-8, except that in the anode active material layer 72B, the ratio (molar ratio) M3/M1 between the number of moles M1 per unit area of the anode active material particles and the number of moles M3 per unit area of the compound layer having Si—O bond and Si—N bond was changed as illustrated in Table 15.

The cycle characteristics for the secondary batteries of Examples 15-1 to 15-4 were examined. The results illustrated in Table 15 were obtained. Table 15 also illustrates the results of Examples 1-8 and 14-8.

TABLE 15
Anode active material: Si (electron beam evaporation method)
Content ratio of oxygen in anode active material: 5 atomic %
Ten point height of roughness profile Rz of surface of anode current
collector: 3.0 μm

| | Anode active material layer | | | | |
|---|---|---|---|---|---|
| | (total film thickness: 8.4 μm) | | | | |
| | Surface treatment | | | Film | Discharge |
| | Formation | | | thickness | capacity |
| | of | Molar | Number | per one | retention |
| | compound | ratio | of layers | layer | ratio |
| | film | M3/M1 | (layer) | (nm) | (%) |
| Example 1-8 | — | — | 28 | 300 | 84 |
| Example 14-8 | Applicable | 1/1 | 28 | 300 | 95 |
| Example 15-1 | Applicable | 0.8/1 | 28 | 300 | 94 |
| Example 15-2 | Applicable | 0.5/1 | 28 | 300 | 92 |
| Example 15-3 | Applicable | 0.1/1 | 28 | 300 | 91 |
| Example 15-4 | Applicable | 0.01/1 | 28 | 300 | 89 |

As illustrated in Table 15, it was found that in the case where the molar ratio (M3/M1) was from 0.01 to 1 both inclusive, the discharge capacity retention ratio was higher than that of Example 1-8 in which the compound layer was not formed. Further, it was found that as the foregoing value became closer to 1, a higher discharge capacity retention ratio was able to be obtained.

### Examples 16-1 to 16-5

A coin type secondary battery was fabricated in the same manner as that of Example 14-8, except that the thickness of the compound layer covering the anode active material particles was changed as illustrated in Table 16.

The cycle characteristics for the secondary batteries of Examples 16-1 to 16-5 were examined. The results illustrated in Table 16 were obtained. Table 16 also illustrates the results of Example 14-8.

TABLE 16
Anode active material: Si (electron beam evaporation method)
Content ratio of oxygen in anode active material: 5 atomic %
Ten point height of roughness profile Rz of surface of anode current
collector: 3.0 μm
Anode active material layer: total film thickness of 8.4 μm, film
thickness per one layer of 300 nm

| | Surface treatment | | | |
|---|---|---|---|---|
| | | | Film | Discharge |
| | Formation of | Molar | thickness | capacity |
| | compound | ratio | of compound | retention ratio |
| | film | M3/M1 | (nm) | (%) |
| Example 16-1 | Applicable | 1/1 | 5 | 85 |
| Example 16-2 | Applicable | 1/1 | 10 | 93 |
| Example 14-8 | Applicable | 1/1 | 100 | 95 |
| Example 16-3 | Applicable | 1/1 | 500 | 94 |
| Example 16-4 | Applicable | 1/1 | 1000 | 92 |
| Example 16-5 | Applicable | 1/1 | 1200 | 84 |

As illustrated in Table 16, it was found that in the case where the thickness of the compound layer was from 10 nm to 1000 nm both inclusive, the discharge capacity retention ratio was able to be higher than that in a case in which the thickness of the compound layer was other value.

### Examples 17-1 to 17-5

A coin type secondary battery was fabricated in the same manner as that of Example 15-2, except that in the anode active material layer 72B, the ratio (molar ratio) M3/M1 between the number of moles M1 per unit area of the anode active material particles and the number of moles M3 per unit area of the compound layer having Si—O bond and Si—N bond was changed as illustrated in Table 17.

The cycle characteristics for the secondary batteries of Examples 17-1 to 17-5 were examined. The results illustrated in Table 17 were obtained. Table 17 also illustrates the results of Example 15-2.

TABLE 17
Anode active material: Si (electron beam evaporation method)
Content ratio of oxygen in anode active material: 5 atomic %
Ten point height of roughness profile Rz of surface of anode current
collector: 3.0 μm
Anode active material layer: total film thickness of 8.4 μm, film
thickness per one layer of 300 nm

| | Surface treatment | | | |
|---|---|---|---|---|
| | | | Film | Discharge |
| | Formation of | Molar | thickness | capacity |
| | compound | ratio | of compound | retention ratio |
| | film | M3/M1 | (nm) | (%) |
| Example 17-1 | Applicable | 0.5/1 | 5 | 83 |
| Example 17-2 | Applicable | 0.5/1 | 10 | 92 |
| Example 15-2 | Applicable | 0.5/1 | 100 | 92 |
| Example 17-3 | Applicable | 0.5/1 | 500 | 91 |
| Example 17-4 | Applicable | 0.5/1 | 1000 | 90 |
| Example 17-5 | Applicable | 0.5/1 | 1200 | 81 |

As illustrated in Table 17, it was found that in the case where the thickness of the compound layer was from 10 nm to 1000 nm both inclusive, the discharge capacity retention ratio was able to be higher than a case in which the thickness of the compound layer was other value.

In the foregoing embodiments and the foregoing examples, the descriptions have been given with the specific examples of the cylindrical type, laminated film type, and square type secondary batteries respectively having a spirally wound battery element (electrode body) and the coin type secondary battery. However, the invention is able to be similarly applied to a secondary battery in which a package member has other shape such as a button type secondary battery or a secondary battery having a battery element (electrode body) with other structure such as a laminated structure.

Usage of the anode is not necessarily limited to the secondary battery, but is able to be similarly applied to an electrochemical device other than the secondary battery. Examples of other usage include a capacitor.

Further, in the foregoing embodiments and the foregoing examples, the description has been given of the case using lithium as an electrode reactant. However, the embodiment is able to be applied to a case that other Group 1 element in the long period periodic table such as sodium (Na) and potassium (K), a Group 2 element in the long period periodic table such as magnesium and calcium, other light metal such as aluminum, or an alloy of lithium or the foregoing element is used, and similar effect is able to be thereby obtained. In this case, the anode active material capable of inserting and extracting an electrode reactant, a cathode active material, a solvent and the like are selected according to the electrode reactant.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An anode having an anode active material layer including a multilayer structure of an anode active material containing silicon as an element on an anode current collector, wherein a thickness of each layer in the multilayer structure ranges from 50 nm to 1050 nm.

2. The anode according to claim 1, wherein the thickness of each layer in the multilayer structure range from 100 nm to 700 nm.

3. The anode according to claim 1, wherein the anode active material layer includes a plurality of anode active material particles provided on the anode current collector, and each anode active material particle has the multilayer structure.

4. The anode according to claim 3, wherein the anode active material layer contains a metal containing a metal element not being alloyed with an electrode reactant in a clearance between the plurality of anode active material particles.

5. The anode according to claim 4, wherein a clearance between the anode active material particles adjacent to each other is densely filled with the metal.

6. The anode according to claim 4, wherein the metal covers at least part of an exposed face of the anode active material particles.

7. The anode according to claim 4, wherein the metal also exists in a portion between each layer in the anode active material particles.

8. The anode according to claim 4, wherein a void inside the anode active material particles is filled with the metal.

9. The anode according to claim 4, wherein the metal contains at least one of iron, cobalt, nickel, zinc, and copper.

10. The anode according to claim 1, wherein a compound layer that has a thickness of 10 nm or more and contains silicon oxide is provided on at least part of a surface of the anode active material layer.

11. The anode according to claim 1, wherein at least part of the anode active material layer is alloyed with the anode current collector in an interface with the anode current collector.

12. The anode according to claim 1, wherein the anode active material contains oxygen as an element, and a content ratio of oxygen in the anode active material ranges from 3 atomic % to 40 atomic %.

13. The anode according to claim 1, wherein the anode active material has an oxygen-containing region that contains oxygen in a thickness direction thereof, and a content ratio of oxygen in the oxygen-containing region is higher than a content ratio of oxygen in the other regions.

14. The anode according to claim 1, wherein the anode active material contains at least one of iron, cobalt, nickel, chromium, titanium, and molybdenum as an element.

15. The anode according to claim 1, wherein ten point height of roughness profile Rz of a surface of the anode current collector ranges from 1.5 μm to 6.5 μm.

16. A secondary battery comprising:
a cathode;
an anode; and
an electrolyte, wherein the anode has an anode active material layer including a multilayer structure of an anode active material containing silicon (Si) as an element on an anode current collector, and
a thickness of each layer in the multilayer structure ranges from 50 nm to 1050 nm.

17. The secondary battery according to claim 16, wherein the electrolyte contains 1,3-propene sultone.

18. The secondary battery according to claim 16, wherein the electrolyte contains at least one of 4-fluoro-1,3-dioxolane-2-one and 4,5-difluoro-1,3-dioxolane-2-one as a solvent.

19. The secondary battery according to claim 16, wherein the electrolyte contains an electrolyte salt containing at least one of LiPF₆ and LiBF₄.

20. The secondary battery according to claim 16, wherein the electrolyte contains at least one of sulfobenzoic acid anhydride and sulfopropionate anhydride.
